(19) United States
(12) Patent Application Publication
(10) Pub. No.: US 2018/0184435 A1
(43) Pub. Date: Jun. 28, 2018

(54) APPARATUS, SYSTEM, AND METHOD FOR TRANSITIONING BETWEEN WIRELESS ACCESS POINTS BASED ON A RECEIVED SIGNAL STRENGTH INDICATOR VALUE OF A LOW-POWER WAKE-UP PACKET

(71) Applicant: Intel IP Corporation, Santa Clara, CA (US)

(72) Inventors: Laurent Cariou, Portland, OR (US); Robert Stacey, Portland, OR (US); Minyoung Park, Portland, OR (US); Po-Kai Huang, San Jose, CA (US); Alexander W. Min, Portland, OR (US)

(73) Assignee: Intel IP Corporation, Santa Clara, CA (US)

(21) Appl. No.: 15/391,332

(22) Filed: Dec. 27, 2016

(51) Int. Cl. H04W 72/08; H04W 52/02; H04L 27/18

(52) U.S. Cl. CPC H04W 72/085; H04W 84/12; H04L 27/18; H04W 52/0203

(57) ABSTRACT

A wireless communication device, a system, and a method. The device may use memory circuitry and processing circuitry to process a packet wirelessly transmitted to the STA from a serving AP. The packet may be configured according to a first wireless communication protocol from a serving AP, such as, for example, WLAN. The wireless communication device may further process a low modulation packet configured according to a second wireless communication protocol from a candidate access point, the low modulation packet being at a modulation rate lower than a lowest modulation rate for the first wireless communication protocol. The second wireless communication protocol may be the LP-WU radio communication protocol. The device may determine a received signal strength indicator (RSSI) value of the low modulation packet, and may further process a frame including information on an address or signature, such as a Service Set Identifier (SSID) for the serving AP corresponding to the candidate access point, the frame being from the serving access point, from the candidate access point, or from another wireless communication device. The device may then associate the RSSI value with the address of the candidate access point, and trigger transition of the device from the serving access point to the candidate access point based on the RSSI value and on the address of the candidate access point.

### TECHNICAL FIELD

Embodiments described herein generally relate to finding access point candidates for basic service set transitions in a wireless network.

### BACKGROUND

Wi-Fi user experience is highly dependent on the stability of the Wi-Fi wireless link even in mobility. For that reason, non-access-point (non-AP) wireless stations (STAs) regularly perform scanning (either active or passive) for alternative candidate access points (APs), especially when the received signal-to-noise ratio (SNR) with the serving AP becomes low. This scanning procedure tends to penalize the performance of the Wi-Fi link and user experience. In case of active scanning, this scanning also tends to overload the channel airtime occupation in dense environments with probe requests and responses. Several improvements have been defined in the Institute of Electrical and Electronic Engineers (IEEE) 802.11 specifications to improve scanning and selection of neighbor APs for basic service set (BSS) transitions. For example, IEEE 802.11v and 802.11ai have defined ways for the AP to send neighbor reports in order to provide information on neighbor/candidate APs (their BSSID, occupied channel, beacon target transmission times). In spite of the above, the discovery of candidate APs is a function that consumes power for the STA, that occupies the airtime, and that disables data transmission and reception during the scanning phase, impacting quality of service (QoS).

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic illustration of an Extended Service Set (ESS) including APs and STAs in various BSSs of the ESS in accordance with some demonstrative embodiments;

FIG. 2 is a schematic illustration of a radio architecture of a STA or an AP from the ESS of FIG. 1 in accordance with some demonstrative embodiments;

FIG. 3 is a schematic illustration of the ESS of FIG. 1 in simplified form;

FIG. 4 is a schematic illustration of a low-power wake-up (LP-WU) packet in accordance with some demonstrative embodiments;

FIG. 5 is a schematic illustration of a product of manufacture in accordance with some demonstrative embodiments; and

FIG. 6 is a schematic flow-chart illustration of a method of transitioning from one access point to another access point using a LP-WU packet, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units, and/or circuits have not been described in detail so as not to obscure the discussion.

Discussions herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems—for example, user equipment (UE), a mobile device (MD), a wireless station (STA), a personal computer (PC), a desktop computer, a mobile computer, a laptop computer, a notebook computer, a tablet computer, a server computer, a handheld computer, a handheld device, an Internet of Things (IoT) device, a sensor device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) 802.11 standards or protocols, including IEEE 802.11-2012, (“IEEE Standard for Information technology—Telecommunications and information exchange between systems Local and metropolitan area networks—Specific requirements Part 11: Wireless LAN Medium Access Control (MAC) and Physical Layer (PHY) Specifications,” Mar. 29, 2012); IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz,” December 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band,” 28 Dec. 2012); IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); and/or IEEE 802.11az (IEEE 802.11az, Next Generation Positioning), and/or future versions and/or derivatives thereof, devices and/or networks operating in accordance with existing Wi-Fi Alliance (WFA) specifications (including WLAN Neighbor Awareness Networking (NAN) Technical Specification, Version 1.0, May 1, 2015) and/or future versions and/or derivatives thereof, devices and/or networks operating in accordance with existing WFA Peer-to-Peer (P2P) specifications (including WLAN P2P technical specification, version 1.5, Aug. 4, 2014) and/or future versions and/or derivatives thereof, devices and/or networks operating in accordance with existing Wireless-Gigabit-Alliance (WGA) specifications (including Wireless Gigabit Alliance, Inc. WiGig MAC and PHY Specification Version 1.1, April 2011, Final specification) and/or future versions and/or derivatives thereof, devices and/or networks operating in accordance with existing cellular specifications and/or protocols, e.g., 3rd Generation Partnership Project (3GPP), 3GPP Long-Term Evolution (LTE) and/or future versions and/or derivatives thereof, units and/or devices which are part of the above networks, and the like.

Some embodiments may be used to communicate in one-way and/or two-way radio communication systems, cellular radio-telephone communication systems, a mobile phone, a cellular telephone, a wireless telephone, a Personal Communication Systems (PCS) device, a PDA device that incorporates a wireless communication device, a mobile or portable global positioning system (GPS) device, a device that incorporates a GPS receiver or transceiver or chip, a device that incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device—for example, a smartphone—a Wireless Application Protocol (WAP) device, or the like.

Some embodiments may be used to communicate one or more types of wireless communication signals or protocols, for example, radio frequency (RF), infrared (IR), frequency-division multiplexing (FDM), orthogonal FDM (OFDM), orthogonal frequency-division multiple access (OFDMA), FDM time-division multiplexing (TDM), time-division multiple access (TDMA), multi-user MIMO (MU-MIMO), spatial division multiple access (SDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), WLAN, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long-Term Evolution (LTE), LTE advanced, Enhanced Data rates for GSM Evolution (EDGE), or the like. Other embodiments may be used in various other devices, systems, and/or networks.

The term “wireless communication device,” as used herein, includes, for example, a portable or non-portable device capable of wireless communication. In some demonstrative embodiments, a wireless communication device may be or may include a peripheral device that is to be integrated with a computer, or a peripheral that is to be attached to a computer. The term “wireless communication device,” as used herein, may include, for example, a smallest chip or integrated circuit that may provide a given described functionality.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a receiver to receive the communication signal from at least one other communication unit such as an AP or a STA. The verb “communicating” may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used to communicate in a WLAN—for example, a WLAN network. Other embodiments may be used in conjunction with any other suitable wireless communication network—for example, a wireless area network, a “piconet,” a WPAN, a WVAN, and the like.

Some demonstrative embodiments may be used to communicate over a frequency band of 2.4 GHz or 5 GHz, and/or a frequency band, such as for Wi-Fi and for low-power wake-up receiver (LP-WUR) communications. However, other embodiments may be implemented utilizing any other suitable wireless communication frequency bands—for example, a sub 1 GHz (S1G) frequency band, an Extremely High Frequency (EHF) band (the millimeter wave (mmWave) frequency band, such as a frequency band within the frequency band of between 20 Ghz and 300 GHZ, such as the 60 Ghz frequency band), WLAN frequency bands, WPAN frequency bands, and the like.

As used herein, the term “circuitry” may refer to, be part of, or include, an Application Specific Integrated Circuit (ASIC), an integrated circuit, an electronic circuit, a processor (shared, dedicated, or group) circuitry, and/or memory circuitry (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware (e.g., silicon blocks of various chips and/or processors). Logic may be included in, and/or implemented as part of, various circuitry (e.g. radio circuitry, receiver circuitry, control circuitry, transmitter circuitry, transceiver circuitry, processor circuitry, or the like). In one example, logic may be embedded in volatile memory and/or non-volatile memory, including random access memory, read-only memory, programmable memory, magnetic memory, flash memory, persistent memory, and the like. Logic may be executed by one or more processors using memory (e.g., registers, buffers, stacks, and the like) coupled to the one or more processors, e.g., as necessary to execute the logic. The term “antenna,” as used herein, may include any suitable configuration, structure, and/or arrangement of one or more antenna elements, components, units, assemblies, and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, or the like.

As of the time of the instant disclosure, a new study group has been formed in IEEE 802.11/Wi-Fi to define a low-power wake-up receiver (LP-WUR) that enables low-power consumption and low latency for 802.11. This LP-WUR can be a companion radio for 802.11. A common subsystem may then be made of a main 802.11 radio and a LP-WUR. The main radio may be used for data transmission and reception, and may be off unless there are packets to be communicated. The LP-WUR may wake up the main radio when packets are to be received, for example, and may be a simple receiver on the STA side without a transmitter, and may be active while the main radio is off. A target power consumption of the LP-WUR may be less than about 100 μWin the active state. A standard based on LP-WUR may use a simple, low modulation scheme such as On-Off Keying (OOK), or Frequency Shift Keying (FSK) on a narrow bandwidth, typically less than about 5 MHz, and may meet the transmission range of the main radio.

The discovery of neighbor APs according to the prior art is a function that consumes power for the STA, that occupies the airtime, and that disables data transmission and reception during the scanning phase, impacting QoS. In many situations, especially for BSS transitions between BSSs from the same ESS, where all APs are often managed by a controller, the STA typically has to estimate the received signal strength indicator (RSSI) of candidate APs. If the RSSI of a candidate AP is better than the serving AP RSSI, or if higher than a specific BSS transition threshold, the BSS transition can be triggered. However, in order to get this RSSI estimation, the STA typically has to receive a beacon, or a fast-initial link set-up (FILS) discovery frame (in the passive scanning mode), or trigger the transmission by the candidate neighbor AP of a probe response (in the active scanning mode).

According to some demonstrative embodiments, we propose to use the LP-WUR in order to enable a STA to perform SNR estimations on the serving AP and on neighbor APs. For example, according to some demonstrative embodiments, every AP in a given environment may regularly transmit a LP-WU packet, which would allow the receiving STA to estimate the RSSI value of the packet in order to determine whether or not to transition to a different AP. The LP-WU packet may further include an address or signature of the transmitting AP. In managed environments, a controller can assign different addresses or signatures to each BSS or its ESS. If the STA can receive a LP-WU packet in a neighbor channel, while receiving or transmitting data packets on the serving AP channel, the scanning process no longer impacts the ongoing transmission/reception and no longer impact user experience/QoS. Instead of the AP addresses being communicated in the LP-WU packet, they may be communicated in the neighbor report sent by the serving AP, in order to allow performance of RSSI value measurement/estimation on the right candidate AP. According to some embodiments, the LP-WU packet would include the address of the transmitting AP, rather than including the address of any specific receiving STA. In the latter case, the LP-WU packet may include information, such as in a field thereof, which indicates that the packet is of type “RSSI measurement.” The packet may be of type “short beacon,” “short discovery frame,” or “short response frame,” to name a few. The receiving STA can then use the LP-WU packet to estimate the RSSI. Since the AP address/addresses is/are known by the STA, it can associate the RSSI value with a specific AP and its address. These LP-WU packets can be sent with a specific interval and at specific target transmission times. The target transmission time and interval can be defined in the specifications and/or advertised by the AP in information elements in beacons and pre-association frames for instance.

The LP-WU packet may carry additional information and be a sort of mini-beacon. For instance, the LP-WU packet may include additional information that may help the STA estimate the throughput or the latency associated with connecting to a given AP. The additional information may for example include estimated airtime (ESP) parameters defined in 802.11 (or a compressed version of the same) to provide information about the backhaul throughput, some AP capabilities, BSS load estimates, and estimated available airtime for the AP. The STA may then combine the above information with the RSSI value estimate to estimate throughput/latency associated with connecting to the AP, and therefore improve its AP selection.

The addresses of candidate APs may be communicated to the STA in various ways according to some demonstrative embodiments. For example, the APs may provide their own LP-WU addresses (that is, addresses of APs that have sent, are sending, or are to send LP-WU packets) to the STA in question in management frames, for instance in an information element in beacons, and/or in pre-association frames, or in a dedicated management frame. In the alternative, a serving AP may include LP-WU addresses in a neighbor report frame to the STA. The neighbor report frame can also include for each candidate AP the target transmission time of its LP-WU packet and/or the interval at which they are transmitted. In the alternative, each AP may send its own address to the STA in the LP-WU packet itself. According to some embodiments, the LP-WU address may be derived from a BSS color.

Based on the transmission of these LP-WU packets from the APs, the STAs can estimate the RSSIs received and associate them with the respective addresses of the APs that sent each LP-WU packet. According to some demonstrative embodiments, these packets may be transmitted with a similar power that is further stable in comparison to the power at which beacons and probe responses are sent by the main 802.11 radio. A STA may then collect the RSSI measurements from its serving AP and from neighbor APs (that are either known because indicated in neighbor reports, or unknown as not indicated in neighbor reports). The STA may use this information to trigger BSS transition between its serving AP and an identified candidate AP, with multiple possible mechanisms. For example, the STA may trigger its own transition if the RSSI of the candidate AP is higher than the one from the serving AP, or if the RSSI of the candidate AP is higher than a threshold. The threshold can be defined by the STA itself, or can be provided by the serving AP, for instance, in the neighbor report common part or in the neighbor report per candidate AP part. In the neighbor report, there could be either a specific RSSI threshold for the serving AP below which scanning by the STA should occur, or a combination of a threshold for the serving AP RSSI below which BSS transition should be triggered, along with a threshold for the neighbor AP RSSI above which BSS transition should be triggered. If the RSSI measured on the LP-WU packet is not calibrated with the RSSI measured on frames sent by the main 802.11 radio, the RSSI measurements made on LP-WU may be compared with the ones made on LP-WU packets. If a calibration is effected, the STA may compare the RSSI measured on LP-WU packets with RSSI measured on frames or packets sent with the main 802.11 packets.

A STA may, according to some demonstrative embodiments, have a way of determining whether a set of APs is from its own ESS, or not. For example, STA may have the list of addresses for all APs from a given ESS linked with that ESS' address, or, it is possible that all APs within the ESS may have a dedicated address for themselves and a separate address that identifies them as being part of the ESS. These addresses may be regularly transmitted by every AP. In this case, a STA in motion and with its main radio in power-save mode without active data traffic may keep its wake-up receiver on and keep scanning the channels to detect the APs from the ESS while being able to ignore APs not from its own ESS. This way, it may always know the best AP from the ESS to connect to when it will wake up when data traffic becomes needed.

In a Wi-Fi—only infrastructure network deployment, a controller of the ESS may set the signature/address of each AP and define the information carried in the LP-WU packets, or, in the alternative, the above functionality could, according to some embodiments, also be performed remotely in the cloud. In addition, if the infrastructure of the network is deployed by an operator with LTE-WLAN Aggregation (LWA) or LTE Radio Level Integration with IPsec (LWIP), or any other interworking solution with Long-Term Evolution (LTE), the Evolution Node B (eNodeB) may also be the one setting these parameters. In such case, it is also possible that the eNodeB may replicate the LWA and LWIP mechanisms to help the STA select the best AP to initiate LWA/LWIP by sending via LTE the list of BSSIDs with the LP-WU addresses, as well as RSSI thresholds specifically for LP-WUR packet receptions. Should the STA measure RSSI above a given threshold, it may then indicate that to the eNodeB, which may trigger LWA on that particular AP.

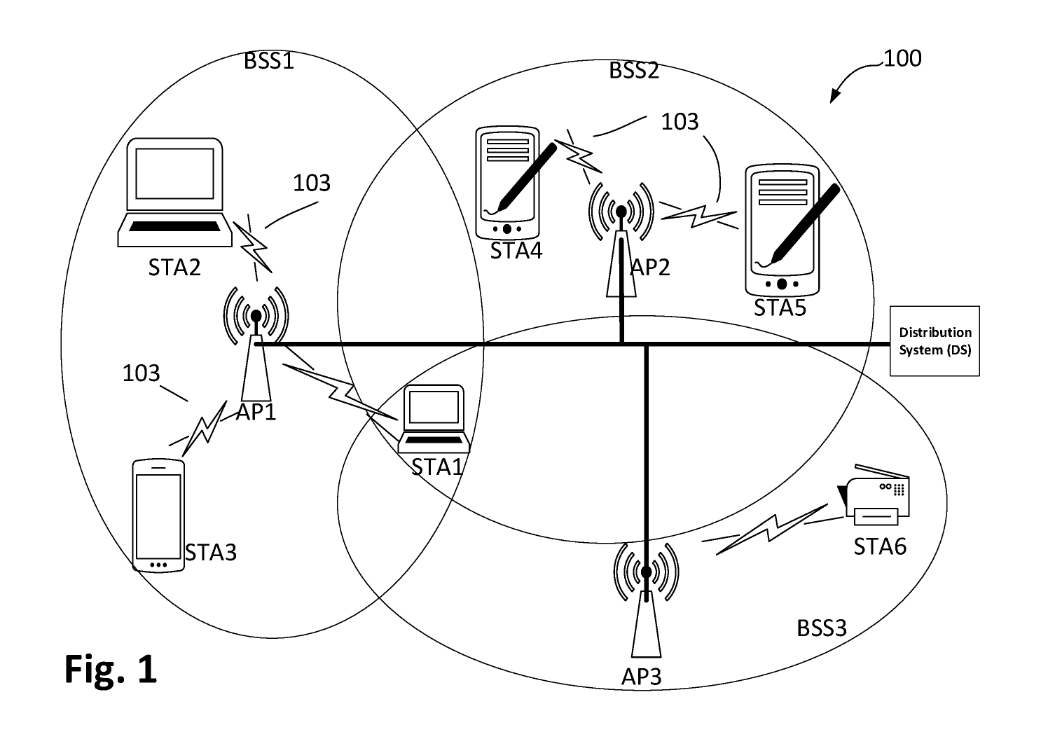

Reference is made to FIG. 1, which schematically illustrates a network in the form of Extended Service Set (ESS) 100, in accordance with some demonstrative embodiments. Embodiments are not limited to ESS networks, however, and may include any other wireless network as would be recognized by a skilled person.

As shown in FIG. 1, in some demonstrative embodiments, ESS 100 may include one or more wireless communication stations capable of communicating content, data, information, audio, video, and/or signals via a wireless medium, such as mobile/portable and non-mobile wireless communication stations STA1, STA2, STA3, STA4, STA5, and STA6. The ESS may be formed according to first wireless communication protocol, such as, for example, WLAN. FIG. 1 additionally shows three access points (APs) AP1, AP2, and AP3, each forming, along with STAs associated therewith, a basic service set (BSS) of the ESS. As shown in FIG. 1 by virtue of BSS association links 103, AP1, STA1, STA2, and STA3 are associated with one another and form BSS1, while AP2, STA4, and STAS are associated with one another and form BSS2, and AP3 and STA6 are associated with one another and form BSS3. As further shown in FIG. 1, the BSSs overlap with one another, although embodiments are not so limited, with STA1 finding itself in the range of both BSS1 and AP1, BSS2 and AP2, and BSS3 and AP3, while associated with AP1 in BSS1. Networks according to some demonstrative embodiments, however, are not limited to the number, configuration, or types of access points (APs) or STAs as shown in FIG. 1, but may include any number of wireless communication stations, whether mobile or not, and any number of BSSs, whether or not in an ESS, forming a wireless network together as would be recognized by a person skilled in the art.

In some demonstrative embodiments, the wireless medium may include, for example, a radio channel, an RF channel, a Wireless Fidelity (WLAN) channel, a cellular channel, an IR channel, a LP-WU channel, and the like. One or more elements of ESS 100 may optionally be capable of communicating over any suitable wired communication links.

In some demonstrative embodiments, a STA within a wireless network may include, for example, user equipment (UE), a mobile device (MD), a WLAN STA, a mobile computer, a laptop computer, an Internet of Things (IoT) device, a sensor device, a notebook computer, a tablet computer, an Ultrabook™ computer, a mobile internet device, a handheld computer, a handheld device, a PDA device, a handheld PDA device, an on-board device, an off-board device, a hybrid device (e.g., combining cellular phone functionalities with PDA device functionalities), a consumer device, a mobile or portable device, a mobile phone, a cellular telephone, a PCS device, a PDA device that incorporates a wireless communication device, a mobile or portable GPS device, a relatively small computing device, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Personal Media Player (PMP), a digital video camera (DVC), a gaming device, a smartphone, or the like.

In some demonstrative embodiments, one or more of the plurality of STAs may include, may perform a role of, and/or may perform the functionality of, an access point (AP) station (STA), or of a non-AP STA.

In one example, STA may include a logical entity that is a singly addressable instance of a medium access control (MAC) and physical layer (PHY) interface to the wireless medium. The STA may perform any other additional or alternative functionality.

In one example, an AP may include an entity that contains a STA, and provides access to distribution services, via the wireless medium for associated STAs. The AP may perform any other additional or alternative functionality, and may be wired to a router, or may be an integral part of a router, to provide connection to a network.

In one example, a non-AP STA may include a STA that is not contained within an AP. The non-AP STA may perform any other additional or alternative functionality.

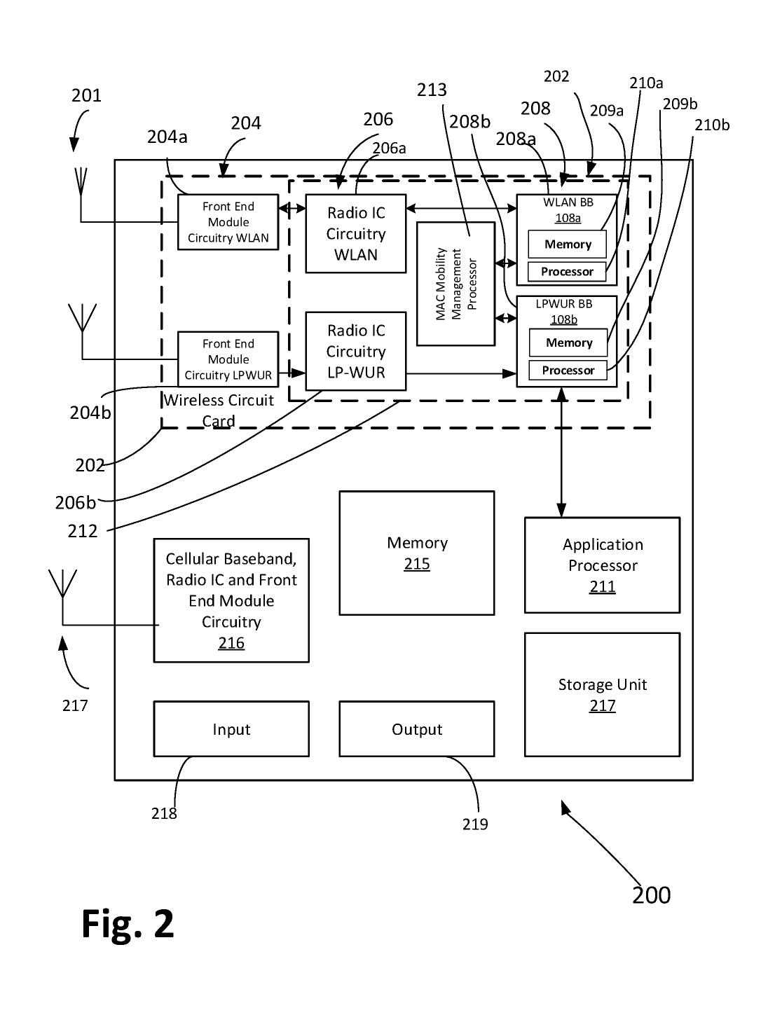

When referring to FIG. 2, it is noted that the figure depicts one embodiment of a STA, or one embodiment of an AP, as would be recognized by a skilled person, although embodiments are not so limited. At certain points within the below description, therefore, FIG. 2 will be referred to as an apparatus including an architecture for a STA 200, while at certain other points within the below description, FIG. 2 will be referred to as an apparatus including an architecture for an AP 200. The context will, however, be clear based on the description being provided.

Referring next to FIG. 2, a block diagram is shown of a wireless communication STA 200 or AP 200, such as any of STA1 through STA6, or AP1 through AP3, according to some demonstrative embodiments. The shown wireless communication station includes a wireless communication radio architecture 201 in accordance with some embodiments. Radio architecture 201 may include radio front-end module (FEM) circuitry 204, radio integrated circuit (IC) circuitry 206, and baseband processing circuitry 208. Radio architecture 201 as shown includes both Wireless Local Area Network (WLAN) functionality and low-power wake-up receiver (LP-WUR) functionality, although embodiments are not so limited. In this disclosure, “WLAN” and “Wi-Fi” are used interchangeably. LP-WUR/LP-WU refers to medium access control layer (MAC) and physical layer (PHY) specifications in accordance with efforts within the Institute of Electrical and Electronics Engineers (IEEE) regarding a LP-WUR standard.

FEM circuitry 204 may include a WLAN or Wi-Fi FEM circuitry 204a and a LP-WU FEM circuitry 204b. The WLAN FEM circuitry 204a may include a receive signal path comprising circuitry configured to operate on WLAN RF signals received from one or more antennas 201, to amplify the received signals and to provide the amplified versions of the received signals to the WLAN radio IC circuitry 206a for further processing. The LP-WU FEM circuitry 204b may include a receive signal path that may include circuitry configured to operate on LP-WU RF signals received from one or more antennas 201, to amplify the received signals and to provide the amplified versions of the received signals to the LP-WU radio IC circuitry 206b for further processing. FEM circuitry 204a may also include a transmit signal path that may include circuitry configured to amplify WLAN signals provided by the radio IC circuitry 206a for wireless transmission by one or more of the antennas 201. The LP-WU signal path as shown does not include a transmit signal path, however, but embodiments include within their scope the possibility of the LP-WU signal path to possibly include a transmit signal path. In the embodiment of FIG. 2, although WLAN or Wi-Fi FEM circuitry 204a and LP-WU FEM circuitry 204b are shown as being distinct from one another, and connected to respective distinct antennas, embodiments are not so limited, and include within their scope the use of an FEM (not shown) that includes a transmit path and/or a receive path for WLAN and LP-WU signals, or the use of one or more FEM circuitries or one or more antennas where at least some of the FEM circuitries and antennas share transmit and/or receive signal paths for WLAN and LP-WU signals.

Radio IC circuitry 206 as shown may include WLAN radio IC circuitry 206a and LP-WU radio IC circuitry 206b. The WLAN radio IC circuitry 206a may include a receive signal path that may include circuitry to down-convert WLAN RF signals received from the FEM circuitry 204a and provide baseband signals to WLAN baseband processing circuitry 208a. LP-WU radio IC circuitry 206b may in turn include a receive signal path that may include circuitry to down-convert LP-WU RF signals received from the FEM circuitry 204b and provide baseband signals to LP-WU baseband processing circuitry 208b. WLAN radio IC circuitry 206a may also include a transmit signal path that may include circuitry to up-convert WLAN baseband signals provided by the WLAN baseband processing circuitry 208a and provide WLAN RF output signals to the FEM circuitry 204a for subsequent wireless transmission by the one or more antennas 201. In the embodiment of FIG. 2, although radio IC circuitries 206a and 206b are shown as being distinct from one another, embodiments are not so limited, and include within their scope the use of a radio IC circuitry (not shown) that includes a transmit signal path and/or a receive signal path for both WLAN and LP-WU signals, or the use of one or more radio IC circuitries where at least some of the radio IC circuitries share transmit and/or receive signal paths for both WLAN and LP-WU signals.

Baseband processing circuitry 208 may include a WLAN baseband processing circuitry 208a and a LP-WU baseband processing circuitry 208b. The WLAN baseband processing circuitry 208a may include a memory 209a, such as, for example, a set of RAM arrays in a Fast Fourier Transform or Inverse Fast Fourier Transform block (not shown) of the WLAN baseband processing circuitry 208a. Each of the WLAN baseband processing circuitry 208a and the LP-WU baseband processing circuitry 208b may further include a memory 209b similar to memory 209a described above, and one or more respective processors 210a and 210b including control logic to process the signals received from the corresponding WLAN or LP-WU receive signal path of the radio IC circuitry 206. WLAN baseband processing circuitry 208a is configured to also generate corresponding WLAN baseband signals for the transmit signal path of the radio IC circuitry 206. Each of the baseband processing circuitries 208a and 208b may further include physical layer (PHY) and medium access control layer (MAC) circuitry, and may further interface with application processor 210 for generation and processing of the baseband signals and for controlling operations of the radio IC circuitry 206. According to some embodiments, the baseband processing circuitries 208a and 208b could be integrated into a single circuitry, with one baseband circuitry fulfilling both WLAN and LP-WUR functionalities.

Referring still to FIG. 2, according to the shown embodiment, a MAC mobility management processor 213 may include a processor having logic to provide a number of higher MAC functionalities, such as, for example, signaling the LP-WU receiver to scan, determining or estimating RSSI values for received packets, comparing RSSI values, enabling a triggering of the WLAN baseband processing circuitry 208a through signals from the LP-WU baseband processing circuitry 208b. In the alternative, or in conjunction with the MAC mobility management processor 213, some of the higher-level MAC functionalities above may be provided by application processor 211. In addition, although the antennas 201 are depicted as being respectively connected to the WLAN FEM circuitry 204a and the LP-WU FEM circuitry 204b, embodiments include within their scope the sharing of one or more antennas as between the WLAN and LP-WU FEMs, or the provision of more than one antenna connected to each of FEM circuitry 204a or 204b.

In some embodiments, the front-end module circuitry 204, the radio IC circuitry 206, and baseband processing circuitry 208 may be provided on a single radio card, such as wireless radio card 202. In some other embodiments, the one or more antennas 201, the FEM circuitry 204, and the radio IC circuitry 206 may be provided on a single radio card. In some other embodiments, the radio IC circuitry 206 and the baseband processing circuitry 208 may be provided on a single chip or integrated circuit (IC), such as IC 212.

In some embodiments, the wireless radio card 202 may include a WLAN radio card and may be configured for Wi-Fi communications, although the scope of the embodiments is not limited in this respect. In some of these embodiments, the radio architecture 201 may be configured to receive and transmit orthogonal frequency division multiplexed (OFDM) or orthogonal frequency division multiple access (OFDMA) communication signals over a multi-carrier communication channel. The OFDM or OFDMA signals may comprise a plurality of orthogonal subcarriers.

In some of these multi-carrier embodiments, radio architecture 201 may be part of a Wi-Fi communication STA such as a wireless AP, a base station, or a mobile device including a Wi-Fi device. In some of these embodiments, radio architecture 201 may be configured to transmit and receive signals in accordance with specific communication standards and/or protocols, such as any of the Institute of Electrical and Electronics Engineers (IEEE) standards, including 802.11n-2009, IEEE 802.11-2012, 802.11n-2009, 802.11ac, and/or 802.11ax standards and/or proposed specifications for WLANs, although the scope of embodiments is not limited in this respect. Radio architecture 201 may also be suitable to transmit and/or receive communications in accordance with other techniques and standards.

In some embodiments, the radio architecture 201 may be configured for high-efficiency Wi-Fi (HEW) communications in accordance with the IEEE 802.11ax standard. In these embodiments, the radio architecture 201 may be configured to communicate in accordance with an OFDMA technique, although the scope of the embodiments is not limited in this respect.

In some other embodiments, the radio architecture 201 may be configured to transmit and receive signals transmitted using one or more other modulation techniques, such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, and On-Off Keying (OOK), although the scope of the embodiments is not limited in this respect.

In some embodiments, the radio architecture 201 may include other radio cards, such as a cellular radio card configured for cellular (e.g., 3GPP such as LTE, LTE-Advanced, or 5G communications).

In some IEEE 802.11 embodiments, the radio architecture 201 may be configured for communication over various channel bandwidths including bandwidths having center frequencies of 900 MHz, 2.4 GHz, 5 GHz, and bandwidths of less than 5 MHz, or of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths), or any combination of the above frequencies or bandwidths, or any frequencies or bandwidths between the ones expressly noted above. In some embodiments, a 320 MHz channel bandwidth may be used. The scope of the embodiments is not limited with respect to the above center frequencies, however.

Referring still to FIG. 2, in some demonstrative embodiments, STA 200 may further include an input unit 218, an output unit 219, and a memory unit 215. STA 200 may optionally include other suitable hardware components and/or software components. In some demonstrative embodiments, some or all of the components of STA 200 may be enclosed in a common housing or packaging, and may be interconnected or operably associated using one or more wired or wireless links. In other embodiments, components of STA 200 may be distributed among multiple or separate devices. It is noted that the exemplary architecture of STA 200 as shown in FIG. 2 and as described above may further be used as part of an architecture for any access points according to some demonstrative embodiments.

In some demonstrative embodiments, application processor 211 may include, for example, a central processing unit (CPU), a digital signal processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an integrated circuit (IC), an application-specific IC (ASIC), or any other suitable multi-purpose or specific processor or controller. Application processor 211 may execute instructions, for example, of an operating system (OS) of STA 200 and/or of one or more suitable applications.

In some demonstrative embodiments, input unit 218 may include, for example, one or more input pins on a circuit board, a keyboard, a keypad, a mouse, a touch-screen, a touch-pad, a track-ball, a stylus, a microphone, or other suitable pointing device or input device. Output unit 219 may include, for example, one or more output pins on a circuit board, a monitor, a screen, a touch-screen, a flat panel display, a light-emitting diode (LED) display unit, a liquid crystal display (LCD) display unit, a plasma display unit, one or more audio speakers or earphones, or other suitable output devices.

In some demonstrative embodiments, memory unit 215 may include, for example, a random-access memory (RAM), a read-only memory (ROM), a dynamic RAM (DRAM), a synchronous DRAM (SD-RAM), a flash memory, a volatile memory, a non-volatile memory, a cache memory, a buffer, a short-term memory unit, a long-term memory unit, or other suitable memory units. Storage unit 217 may include, for example, a hard disk drive, a floppy disk drive, a compact disk (CD) drive, a CD-ROM drive, a DVD drive, or other suitable removable or non-removable storage units. Memory unit 215 and/or storage unit 217, for example, may store data processed by STA 200.

As used below, “serving AP” refers to an AP with which a given STA is associated in a BSS. “Candidate AP” refers to an AP within range of the given STA with which a STA is not yet associated. “Low modulation packet” means a wireless packet that is modulated at a lower rate as compared with some other packets within a wireless network. Moreover, in this description, WLAN, Wi-Fi and an IEEE 802.11 standard such as, by way of example only, 802.11b, 802.11g, 802.11n, 802.11-2012, 802.11ac, and 802.11ax, are used interchangeably. In addition, when “at least one of” a given set or list of items connected with “and” is mentioned herein, what is meant is a reference to either one of the noted items or any combination of the items. For example, as used herein, “at least one of A, B, and C” means A, or B, or C, or A and B, or A and C, or B and C, or A and B and C.

According to some demonstrative embodiments, a wireless communication device, such as, for example, a LP-WU baseband circuitry in a STA, may use its memory and its processing circuitry, including the control logic within processing circuitry, to process a packet wirelessly transmitted to the STA from a serving AP and received through a receive signal path of the STA. The packet may be configured according to a first wireless communication protocol from a serving AP, such as, for example, WLAN, although embodiments are not so limited. The wireless communication device may further process a low modulation packet configured according to a second wireless communication protocol from a candidate access point, the low modulation packet being at a modulation rate lower than a lowest modulation rate for the first wireless communication protocol. For example, the second wireless communication protocol may be the LP-WU radio communication protocol, although embodiments are not so limited. The device may determine a received signal strength indicator (RSSI) value of the low modulation packet—for example, through estimation—in a manner familiar to a person skilled in the art. The wireless communication device may further process a frame including information on an address or signature, such as a Service Set Identifier (SSID) for the serving AP (although embodiments are not limited to a SSID for the address/signature), corresponding to the candidate access point, the frame being from the serving access point, from the candidate access point, or from another wireless communication device. The device may then associate the RSSI value with the address of the candidate access point, and trigger transition of the device from the serving access point to the candidate access point based on the RSSI value and on the address of the candidate access point.

Reference will now be made to FIGS. 1, 2, and 3 in order to describe some demonstrative embodiments, although it is to be noted that embodiments are not limited to what is described below and shown with respect to FIG. 1, or 2, or 3, or any of the other figures included herein.

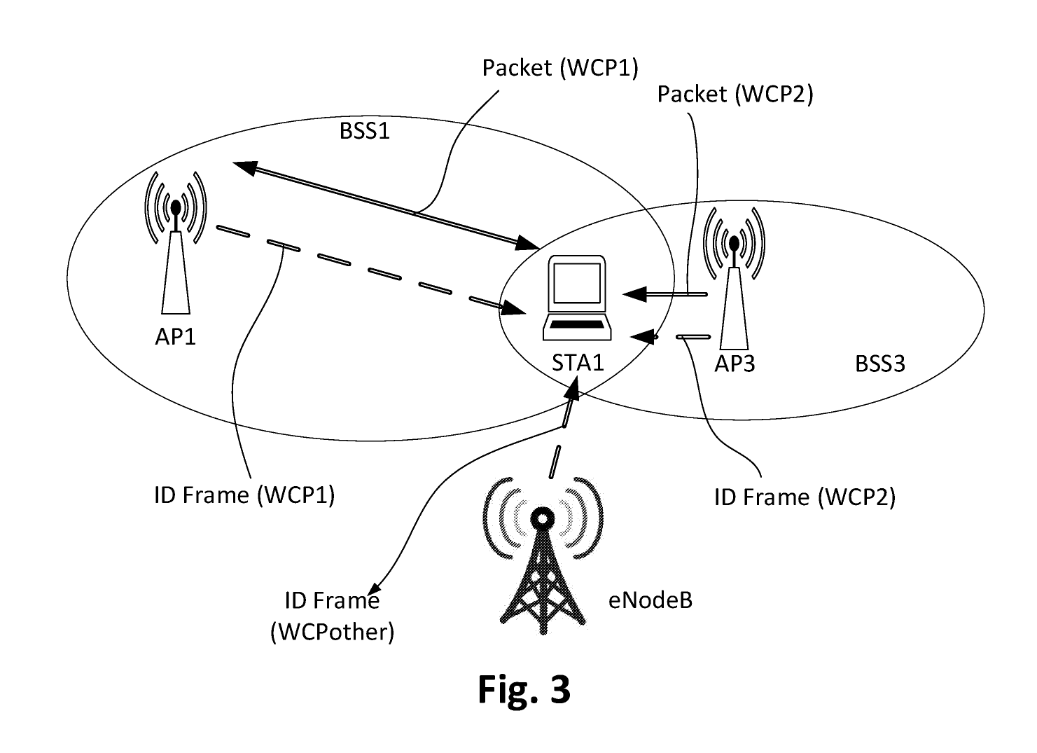

Referring now to FIGS. 1 and 2, a wireless communication device, such as, for example, IC 212 of STA 200, may use its WLAN baseband processing circuitry including memory 209b and processor 210b and control logic within the processor 210b, to process a packet wirelessly transmitted to the STA 200 from a serving AP, such as serving AP1 of FIG. 1. The packet may, for example, be in a management frame, a control frame, or a data frame, and may be received through a receive signal path of the STA by way of FEM circuitry 204a. The packet may be configured according to a first wireless communication protocol from the serving AP1, such as, for example, an IEEE 802.11 standard, although embodiments are not so limited. This packet may, for example, include one or more data packets being transmitted by or received by the STA 200 to or from AP1 using WLAN. The wireless communication device, shown here in the form of IC 212, may further process a low modulation packet (an exemplary embodiment of which is described further below in relation to FIG. 3) configured according to a second wireless communication protocol from a candidate access point, such as AP3, the low modulation packet being at a modulation rate lower than a lowest modulation rate for the first wireless communication protocol. For example, the second wireless communication protocol may be the LP-WUR communication protocol, and the modulation rate of the low modulation packet may be an On-Off Keying (OOK) modulation rate for the packet or a Frequency Shift Keying (FSK) modulation rate for the packet, while a lowest modulation rate for the first wireless communication protocol, such as WLAN, may be a Binary Phase Shift Keying (BPSK) modulation rate although embodiments are not so limited, and may include any set of modulation rates according to embodiments.

According to the second wireless communication protocol, the second wireless communication protocol may use orthogonal frequency division multiplexing (OFDM), or it may be a single-carrier communication protocol. Where OFDM is used, a subcarrier width for the low modulation packet may be about 312.5 kHz, although widths that are, for example, four times slower may also be possible. Modulation of the signal may use On-Off Keying (OOK), and an OOK pulse bandwidth of the low modulation packet may be about 4.06 MHz. A symbol duration of the low modulation packet may be about 4 microseconds. The low modulation packet may be sent on a wireless channel that has a bandwidth of about 5 MHz or less. In addition, there may be 13 subcarriers in a given pulse of the signal.

STA 200, such as, for example, through MAC mobility management processor 213 and/or the application processor 211, or through another processor on or beyond IC 212, may determine a received signal strength indicator (RSSI) value of the low modulation packet—for example, through estimation—in a manner familiar to a person skilled in the art. The wireless communication device, in the shown embodiment in the form of IC 212, may further process a frame that is transmitted to the STA 200, and that further includes information on an address or signature, such as a Service Set Identifier (SSID) for the serving API (although embodiments are not limited to a SSID for the address/signature), corresponding to the candidate AP1. This frame containing the address or signature of the serving AP may be either from the serving access point AP1, from the candidate access point AP3, or from another wireless communication device, such as, for example, a cellular base station or Evolved Node B (eNodeB). The frame may be configured according to the first wireless communication protocol, such as WLAN, a second wireless communication protocol, such as LP-WU, or another wireless communication protocol, such as the Long-Term Evolution (LTE) standard or a 5^{th} Generation Mobile Networks standard (5G).

STA 200 may then, through MAC mobility management processor 213 and/or the application processor 211, or through another processor on or beyond IC 212, associate the RSSI value with the address of the candidate access point, and trigger transition of the device from the serving access point AP1 and a candidate BSS BSS1 associated with the serving access point AP1 to the candidate access point AP3 and a candidate BSS BSS3 associated with the candidate access point AP3 based on the RSSI value and on the address of the candidate access point AP3.

Referring still to FIG. 2, the shown architecture may be deemed to represent an AP 200, according to some demonstrative embodiments. Here, WLAN baseband processing circuitry 208a may be configured to process a packet configured according to a first wireless communication protocol from a wireless station, while LP-WU baseband processing circuitry 208b may be configured to cause transmission to the wireless station of a low modulation packet configured according to a second wireless communication protocol, the low modulation packet being at a modulation rate lower than a lowest modulation rate for the first wireless communication protocol. According to one demonstrative embodiment, the packet configured according to the first wireless communication protocol from the AP 200 and the low modulation packet configured according to the second wireless communication protocol from the AP 200 may both have a legacy PHY preamble according to the first wireless communication protocol. According to some demonstrative embodiments, the second wireless communication protocol may include a low-power wake-up receiver (LP-WUR) protocol conforming to Institute for Electronic and Electrical Engineers (IEEE) 802.11 standard, and the first communication protocol may include a standard from an 802.11 standards family of the Institute for Electronic and Electrical Engineers (IEEE), the lowest modulation rate being a Binary Phase Shift Keying (BPSK) modulation rate.

Referring now to FIG. 3, where like reference numerals refer to like elements, a schematic illustration of communications according to some demonstrative embodiments is shown between AP1, AP3, and STA1 of FIG. 1. The communications are depicted in FIG. 3 by way of arrows extending between AP1, AP3, and STA1, and their depiction as shown does not by itself bear upon whether the various communications happen simultaneously, in series, or in any given sequence. The communication arrows merely depict packets or frame being communicated between AP1, AP3, and STA1 in any appropriate sequence. FIG. 3 further depicts the BSS1 and BSS3 of FIG. 1 but in simplified format. As shown in FIG. 3, AP1 (the serving AP) and STA1 may be in communication with one another through transmission of a packet therebetween, such as a data packet, according to a first wireless communication protocol, such as WLAN, as depicted by Packet (WCP1). The wireless communication device, shown here in the form of IC 212, may further receive a low modulation packet from AP3 according to a second wireless communication protocol, such as LP-WU, as shown by Packet (WCP2). The Packet (WCP2), according to some embodiments, may be at a modulation rate lower than a lowest modulation rate for the first wireless communication protocol. For example, the second wireless communication protocol may be the LP-WU radio communication protocol, and the modulation rate of the low modulation packet may be an On-Off Keying (OOK) modulation rate for the packet, while a lowest modulation rate for the first wireless communication protocol, such as WLAN, may be a Binary Phase Shift Keying (BPSK) modulation rate, although embodiments are not so limited, and may include any set of modulation rates according to embodiments. According to some demonstrative embodiments, STA1 may be configured to communicate Packet (WCP1) at the same time as receiving Packet (WCP2) in its low-power wake-up receiver, in this way facilitating transition to BSS3 if needed. However, STA1 may further receive Packet (WCP2) while it is in sleep mode—that is, while its radio, such as WLAN radio, is not capable of communicating any packets.

As further shown in FIG. 3, a frame may be received by STA 200 that includes the address or signature of AP3 (the candidate access point). This frame is shown in three different ways by broken lines in FIG. 3, as it could be either from the serving access point AP1 according to the first wireless communication protocol, for example WLAN (ID Frame (WCP1)), from the candidate access point AP3 according to the second wireless communication protocol such as LP-WU (ID Frame (WCP2)), or from another wireless communication device, such as, for example, a cellular base station or Evolved Node B (eNodeB) according to another wireless communication standard (ID Frame (WCPother)). In some demonstrative embodiments, Packet (WCP2) may be included in ID Frame (WCP2), such that they are in fact part of the same transmission from AP1 to STA1. In other demonstrative embodiments, Packet (WCP1) may be included in ID Frame (WCP1), such that they are in fact part of the same transmission from AP1 to STA1. This can be the case as long as the ID Frame transmits one or more candidate AP addresses to STA1.

Embodiments are not limited scenarios where only a single candidate AP and a single corresponding low modulation packet, Packet (WCP2), are provided to STA1. Rather, referring back to FIG. 1, some demonstrative embodiments may include a sending of low modulation packets similar to Packet (WCP2) of FIG. 3 from multiple candidate APs to STA1, such as both AP2 and AP3. In such instances, to the extent that all of the addresses of the candidate APs would need to be communicated to STA1, a frame sent to STA1 including all addresses of candidate APs may be sent from AP1, or from another device such as an eNodeB, and may include addresses of candidate APs (neighbor APs). The neighbor report frame may further have a neighbor report common part, and a neighbor report per candidate access point part, and may also include information on a predetermined RSSI threshold value in the neighbor report common part or in the neighbor report per candidate access point part. In this case, STA1 may trigger its transition from AP1 and BSS1 to one of the plurality of candidate access points, AP2 or AP3, and its corresponding candidate BSS, BSS2 or BSS3, based on the RSSI values and the corresponding addresses of the candidate access points.

Referring again to FIG. 2, STA 200 may, through MAC mobility management processor 213 and/or the application processor 211, or through another processor on or beyond IC 212, compare the RSSI value of the low modulation packet from the candidate access point AP3 with an RSSI value associated with the serving access point AP1. Referring again to FIG. 3, the RSSI value associated with the serving access point AP1 may be determined from ID Frame (WCP1) or from Packet (WCP1). Where more than one candidate access point is provided, such as AP2 and AP3 of FIG. 3, a STA according to demonstrative embodiments may make a comparison of all RSSI values for packets from all candidate APs and from the serving AP. An RSSI value comparison as noted above, in addition to use of all neighbor AP addresses including the serving AP and the candidate AP, would allow the STA to trigger transition to one of the candidate access points associated with a highest RSSI value, or to one of the candidate access points with an RSSI value above a predetermined RSSI threshold value. The predetermined threshold value may be transmitted, for example, from STA1 to AP1, for example, through regular packet transmissions between the two using WLAN, although embodiments are not so limited. Processor 210b may, for example, start scanning for LP-WU low modulation packets if an RSSI value of a packet from the serving access point is below the predetermined RSSI threshold. Where a comparison is being made of an RSSI value of a packet according to the first wireless communication protocol from the serving access point with the RSSI value of a low modulation packet according to the second wireless communication protocol, the STA1 may calibrate one of the RSSI values to allow the comparison.

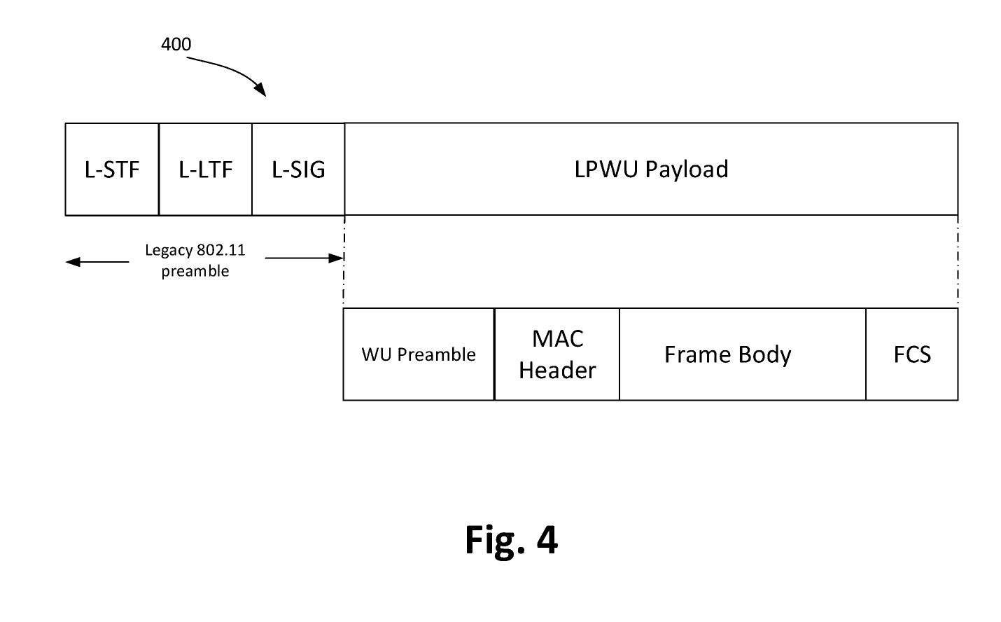

Referring next to FIG. 4, a low modulation packet 400 according to an exemplary embodiment is shown, where the packet is configured according to the LP-WU communication protocol, and includes a legacy 802.11 preamble including a legacy short training field (L-STF), a legacy long training field (L-LTF), a legacy signal field (L-SIG), followed by a LP-WU payload. The legacy 802.11 preamble would allow legacy 802.11 STA to detect the beginning of the low modulation packet through L-STF, and the end of the same through information within L-SIG. The LP-WU payload may include a wake-up preamble, a MAC header including an address of the receiving STA, a frame body, and a frame check sequence field (FCS) for error correction. The low modulation packet 400 may include information in a field, such as in the frame body, that the low modulation packet is of a received signal strength indicator (RSSI) measurement type. The low modulation packet may be in a management frame, and may be a short beacon type packet, a short discovery frame type packet, or a short probe response type packet.

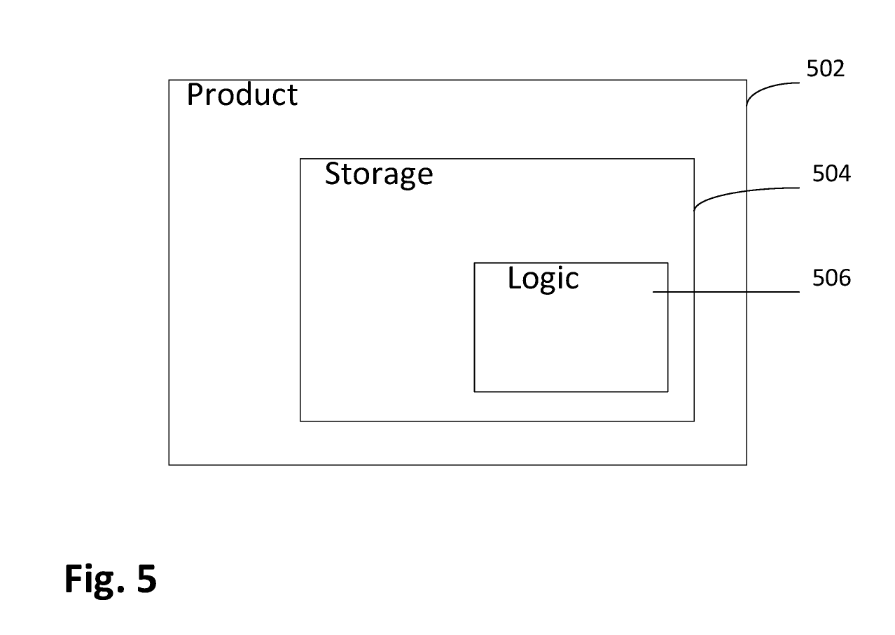

Reference is made to FIG. 5, which schematically illustrates a product of manufacture 500, in accordance with some demonstrative embodiments. Product 500 may include one or more tangible computer-readable non-transitory storage media 502, which may include computer-executable instructions, for example, implemented by logic 504, operable to, when executed by at least one computer processor, enable the at least one computer processor to implement one or more operations at one or more STAs or APs, and/or to perform one or more operations described above with respect to FIGS. 1, 2, 3, and/or 4, and/or one or more operations described herein. The phrase “non-transitory machine-readable medium” is directed to include all computer-readable media, with the sole exception being a transitory propagating signal.

In some demonstrative embodiments, product 500 and/or storage media 502 may include one or more types of computer-readable storage media capable of storing data, including volatile memory, non-volatile memory, removable or non-removable memory, erasable or non-erasable memory, writeable or re-writeable memory, and the like. For example, storage media 502 may include RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), compact disk ROM (CD-ROM), compact disk recordable (CD-R), compact disk rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link (e.g., a modem, radio, or network connection).

In some demonstrative embodiments, logic 504 may include instructions, data, and/or code, which, if executed by a machine, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled, and/or interpreted programming language, such as C, C++, Java, BASIC, Matlab, Pascal, Visual BASIC, assembly language, machine code, and the like.

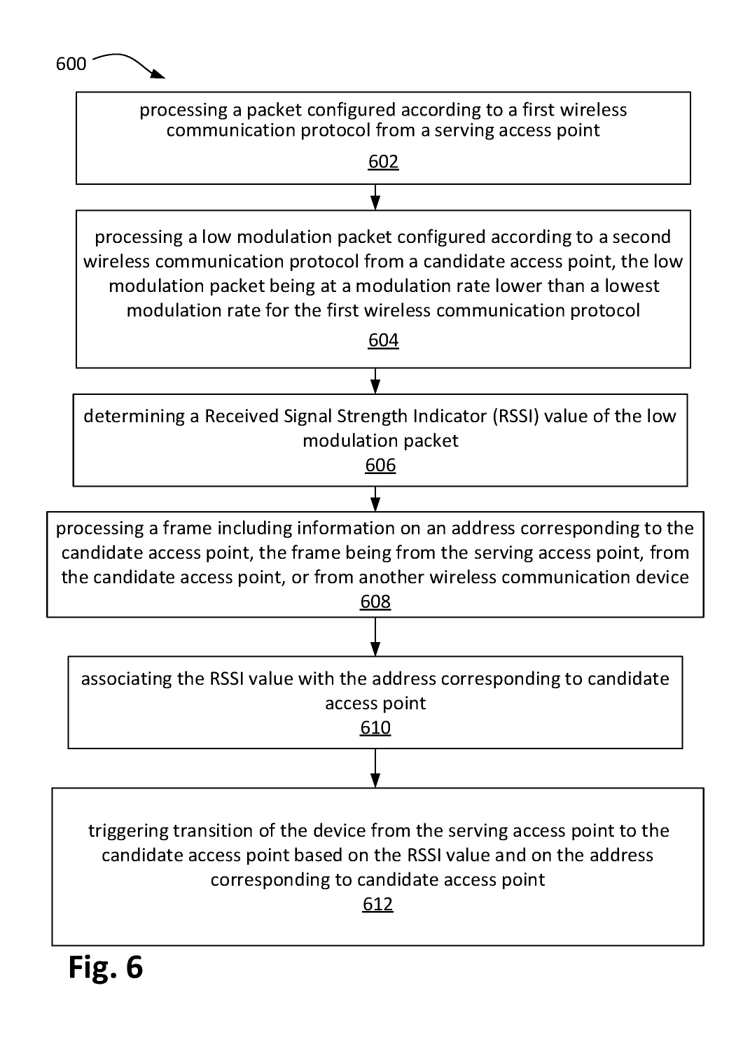

Reference is made to FIG. 6, which schematically illustrates a method in accordance with some demonstrative embodiments. For example, one or more of the operations of the method 600 of FIG. 6 may be performed by one or more elements of a STA, such as STA 200 of FIG. 2.

As indicated at block 602, the method may include processing a packet configured according to a first wireless communication protocol from a serving access point. For example, the WLAN baseband processing circuitry 208a of FIG. 2 may be used to process the packet, and the packet may be from AP1 in FIG. 1 or FIG. 3.

As indicated at block 604, the method may include processing a low modulation packet configured according to a second wireless communication protocol from a candidate access point, the low modulation packet being at a modulation rate lower than a lowest modulation rate for the first wireless communication protocol. For example, LP-WU baseband processing circuitry 208b of FIG. 2 may be used to process the low modulation packet, and the low modulation packet may be from either AP1 or AP3 as shown in FIG. 1 or FIG. 3.

As indicated at block 606, the method may include determining a received signal strength indicator (RSSI) value of the low modulation packet. For example, the MAC mobility management processor 213 or application processor 211 may determine an RSSI value of the low modulation packet from AP1 or AP3 of FIG. 1 or FIG. 3.

As indicated at block 608, the method may include processing a frame including information on an address of the candidate access point, the frame being from the serving access point, from the candidate access point, or from another wireless communication device. For example, WLAN baseband processing circuitry 208a may be used to process a frame, such as a neighbor reporting frame or other frame, from either the serving access point AP1 of FIG. 3, the candidate access point AP3 of FIG. 3, or another device, such as, for example, eNodeB in FIG. 3.

As indicated at block 610, the method may include associating the RSSI value with the address of the candidate access point. For example, the MAC mobility management processor 213 or application processor 211 of FIG. 2 may associate the RSSI value with the address of the candidate access point AP3 of FIG. 2.

As indicated at block 612, the method may include triggering transition of the device from the serving access point to the candidate access point based on the RSSI value and on the address of the candidate access point. For example, the MAC mobility management processor 213 or application processor 211 of FIG. 2 may trigger transition of the STA 200 from the serving access point AP1 and candidate BSS BSS1 associated with AP1 to the candidate access point AP3 and the candidate BSS associated with access point AP3.

### EXAMPLES

The following examples pertain to further embodiments.

Example 1 includes a wireless communication device including a memory and processing circuitry coupled to the memory and including logic to: process a packet configured according to a first wireless communication protocol from a serving access point; process a low modulation packet configured according to a second wireless communication protocol from a candidate access point, the low modulation packet being at a modulation rate lower than a lowest modulation rate for the first wireless communication protocol; determine a received signal strength indicator (RSSI) value of the low modulation packet; process a frame including information on an address of the candidate access point—the frame being from the serving access point, from the candidate access point, or from another wireless communication device; associate the RSSI value with the address of the candidate access point; and trigger transition of the device from the serving access point to the candidate access point based on the RSSI value and on the address of the candidate access point.

Example 2 includes the subject matter of Example 1, and optionally, wherein the second wireless communication protocol includes a low-power wake-up receiver (LP-WUR) protocol conforming to Institute for Electronic and Electrical Engineers (IEEE) 802.11 standard and wherein the modulation rate of the low modulation packet is an On-Off Keying (OOK) modulation rate.

Example 3 includes the subject matter of Example 1, and optionally, wherein the first communication protocol includes a standard from an 802.11 standards family of the Institute for Electronic and Electrical Engineers (IEEE), the lowest modulation rate being a Binary Phase Shift Keying (BPSK) modulation rate.

Example 4 includes the subject matter of any one of Examples 1-3, and optionally, wherein the low modulation packet is sent on wireless channel that has a bandwidth of about 5 MHz or less.

Example 5 includes the subject matter of any one of Examples 1-3, and optionally, wherein the candidate access point includes a plurality of candidate access points, the address of a candidate access point includes a plurality of addresses for respective ones of the candidate access points, the candidate BSS includes a plurality of candidate BSSs each corresponding to a respective one of the candidate access points, the low modulation packet includes a plurality of low modulation packets, each of the low modulation packets further being from a corresponding one of the candidate access points and further being at a modulation rate lower than a lowest modulation rate for the first wireless communication protocol, the RSSI value includes a plurality of RSSI values for each of the low modulation packets, and the logic is to trigger transition of the device from the serving access point and the candidate BSS to one of the plurality of candidate access points and its corresponding candidate BSS based on the RSSI values and the corresponding addresses of the candidate access points.

Example 6 includes the subject matter of Example 5, wherein the frame is a neighbor report frame from the serving access point, the neighbor report frame including information on a timing for a transmission of the low modulation packet from the candidate access point to allow the logic to associate the RSSI value with the address of the candidate access point.

Example 7 includes the subject matter of Example 6, wherein the frame is configured according to the first wireless communication protocol.

Example 8 includes the subject matter of Example 6, and optionally, wherein the information on the timing for the transmission of the low modulation packet includes at least one of a target transmission time of the low modulation packet and an interval at which the low modulation packet is to be transmitted.

Example 9 includes the subject matter of Example 1, and optionally, wherein the frame includes the low modulation packet and is from the candidate access point, and wherein the low modulation packet includes the information on the address of the candidate access point.

Example 10 includes the subject matter of Example 1, and optionally, wherein the low modulation packet is a first low modulation packet, and the logic is further to process a second low modulation packet configured according to the second wireless communication protocol from the serving access point, the second low modulation packet being at the power level that is lower than a lowest power level for the first wireless communication protocol; determine an RSSI value of the second low modulation packet; and trigger transition of the device from the serving access point to the candidate access point based on a comparison of the RSSI value of the first low modulation packet with the RSSI value of the second low modulation packet.

Example 11 includes the subject matter of Example 1, and optionally, wherein the frame is from the serving access point, the device further including logic to determine an RSSI value of the packet configured according to the first wireless communication protocol from the serving access point or of the frame sent from the serving access point, and to trigger transition of the device from the serving access point to the candidate access point based on a comparison of the RSSI value of the low modulation packet with the RSSI value of the packet configured according to the first wireless communication protocol from the serving access point or of the frame sent from the serving access point.

Example 12 includes the subject matter of Example 1, and optionally, wherein the low modulation packet further includes information in a field that the low modulation packet is of a received signal strength indicator (RSSI) measurement type.

Example 13 includes the subject matter of Example 1, and optionally, wherein the low modulation packet is in a management frame, and is a short beacon type packet, a short discovery frame type packet, or a short probe response type packet.

Example 14 includes the subject matter of Example 5, and optionally, wherein the low modulation packet further includes additional information, a backhaul throughput, access point capabilities, BSS load estimates, and estimated available airtime for the candidate access points, and wherein the logic is further to combine the additional information with the RSSI values and the corresponding addresses to trigger the transition.

Example 15 includes the subject matter of any one of Examples 1-3, and optionally, wherein the logic is further to compare the RSSI value of the low modulation packet from the candidate access point with an RSSI value associated with the serving access point or with other candidate access points, and to trigger transition to one of the candidate access points associated with a highest RSSI value, or to one of the candidate access points with an RSSI value above a predetermined RSSI threshold value.

Example 16 includes the subject matter of Example 15, wherein the logic is to cause a transmission of information on the predetermined RSSI threshold value from the device to the serving access point.

Example 17 includes the subject matter of Example 15, and optionally, wherein the frame is a neighbor report frame from the serving access point having a neighbor report common part, and a neighbor report per candidate access point part, and wherein the neighbor report frame includes information on the predetermined RSSI threshold value in the neighbor report common part or in the neighbor report per candidate access point part.

Example 18 includes the subject matter of Example 15, and optionally, wherein the logic is further to cause the processor to start scanning for the low modulation packet if an RSSI value of a packet from the serving access point is below the predetermined RSSI threshold.

Example 19 includes the subject matter of Example 11, and optionally, wherein the logic is further to calibrate an RSSI value of the packet configured according to the first wireless communication protocol from the serving access point or the RSSI value of the low modulation packet to allow the comparison.

Example 20 includes the subject matter of any one of Examples 1-3 and 9-14, and optionally, wherein the logic is further to determine an RSSI value of the low modulation packet when processing the packet configured according to the first wireless communication protocol from the serving access point.

Example 21 includes the subject matter of any one of Examples 1-3 and 9-14, and optionally, wherein the logic is further to determine the RSSI value of the low modulation packet when in a power save mode.

Example 22 includes the subject matter of any one of claims 1-3, and optionally, further including a first radio and first front end module to carry signals configured according to the first wireless communication protocol, a first baseband processor connected to the first radio and first front-end module, a second radio and second front-end module to carry signals configured according to the second wireless communication protocol, a second baseband processor connected to the second radio and second front-end module.

Example 23 includes the subject matter of Example 22, and optionally, further including one or more antennas connected to the first front-end module and the second front end module to communicate signals configured according to the first wireless communication protocol and the second wireless communication protocol.

Example 24 includes the subject matter of Example 5, and optionally, wherein the other wireless communication device is an Evolved Node B (eNodeB), and the frame is from the eNodeB and is configured according to a cellular communication protocol.

Example 25 includes the subject matter of Example 24, where the cellular communication protocol is a Long-Term Evolution (LTE) standard or a Fifth-Generation Mobile Networks Standard.

Example 26 includes the subject matter of any one of Examples 1-3, and optionally, wherein the modulation rate of the low modulation packet is an On-Off Keying (OOK) modulation rate.

Example 27 includes the subject matter of any one of Examples 1-3, and optionally, wherein the first and second wireless communication protocol both use orthogonal frequency division multiplexing (OFDM).

Example 28 includes the subject matter of Example 27, and optionally, wherein a subcarrier width for the low modulation packet may be 312.5 kHz.

Example 29 includes the subject matter of Example 26, and optionally, wherein an OOK pulse bandwidth of the low modulation packet is 4.06 MHz.

Example 30 includes the subject matter of Example 26, and optionally, wherein an OOK pulse bandwidth includes 13 subcarriers.

Example 31 includes the subject matter of any one of Examples 1-3, and optionally, wherein the packet configured according to the first wireless communication protocol from the serving access point and the low modulation packet configured according to the second wireless communication protocol from the candidate access point both have a legacy PHY preamble according to the first wireless communication protocol.

Example 32 includes a system for wireless communication including a wireless communication station comprising one or more antennas, a memory, and a processor including logic to cause the mobile station to: process a packet configured according to a first wireless communication protocol from a serving access point; process a low modulation packet configured according to a second wireless communication protocol from a candidate access point, the low modulation packet being at a modulation rate lower than a lowest modulation rate for the first wireless communication protocol; determine a received signal strength indicator (RSSI) value of the low modulation packet; process a frame including information on an address of the candidate access point, the frame being from the serving access point, from the candidate access point, or from another wireless communication device; associate the RSSI value with the address of the candidate access point; and trigger transition of the device from the serving access point to the candidate access point based on the RSSI value and on the address of the candidate access point.

Example 33 includes the system of Example 32, and optionally, wherein the second wireless communication protocol includes a low-power wake-up receiver (LP-WUR) protocol conforming to Institute for Electronic and Electrical Engineers (IEEE) 802.11 standard.

Example 34 includes the subject matter of Example 32, and optionally, wherein the first communication protocol includes a standard from an 802.11 standards family of the Institute for Electronic and Electrical Engineers (IEEE), the lowest modulation rate being a Binary Phase Shift Keying (BPSK) modulation rate.

Example 35 includes the subject matter of any one of Examples 32-34 and optionally, wherein the low modulation packet is sent on wireless channel that has a bandwidth of about 5 MHz or less.

Example 36 includes the subject matter of Example 32, and optionally, wherein the candidate access point includes a plurality of candidate access points; the address of a candidate access point includes a plurality of addresses for respective ones of the candidate access points; the candidate BSS includes a plurality of candidate BSSs each corresponding to a respective one of the candidate access points; the low modulation packet includes a plurality of low modulation packets, each of the low modulation packets further being from a corresponding one of the candidate access points and further being at a modulation rate lower than a lowest modulation rate for the first wireless communication protocol, the RSSI value includes a plurality of RSSI values for each of the low modulation packets; and the logic is to trigger transition of the device from the serving access point and the candidate BSS to one of the plurality of candidate access points and its corresponding candidate BSS based on the RSSI values and the corresponding addresses of the candidate access points.

Example 37 includes the subject matter of Example 36, and optionally, wherein the frame is a neighbor report frame from the serving access point, the neighbor report frame including information on a timing for a transmission of the low modulation packet from the candidate access point to allow the logic to associate the RSSI value with the address of the candidate access point.

Example 38 includes the subject matter of Example 37, and optionally, wherein the frame is configured according to the first wireless communication protocol.

Example 39 includes the subject matter of Example 37, and optionally, wherein the information on the timing for the transmission of the low modulation packet includes at least one of a target transmission time of the low modulation packet and an interval at which the low modulation packet is to be transmitted.

Example 40 includes the subject matter of Example 32, and optionally, wherein the frame includes the low modulation packet and is from the candidate access point, and wherein the low modulation packet includes the information on the address of the candidate access point.

Example 41 includes the subject matter of Example 32, and optionally, wherein the low modulation packet is a first low modulation packet, and the logic is further to process a second low modulation packet configured according to the second wireless communication protocol from the serving access point, the second low modulation packet being at the power level that is lower than a lowest power level for the first wireless communication protocol; determine an RSSI value of the second low modulation packet; and trigger transition of the device from the serving access point to the candidate access point based on a comparison of the RSSI value of the first low modulation packet with the RSSI value of the second low modulation packet.

Example 42 includes the subject matter of Example 32, and optionally, wherein the frame is from the serving access point, the device further including logic to determine an RSSI value of the packet configured according to the first wireless communication protocol from the serving access point or of the frame sent from the serving access point, and trigger transition of the device from the serving access point to the candidate access point based on a comparison of the RSSI value of the low modulation packet with the RSSI value of the packet configured according to the first wireless communication protocol from the serving access point or of the frame sent from the serving access point.

Example 43 includes the subject matter of Example 32, and optionally, wherein the low modulation packet further includes information in a field that the low modulation packet is of a received signal strength indicator (RSSI) measurement type.

Example 44 includes the subject matter of Example 32, and optionally, wherein the low modulation packet is a short beacon type packet, a short discovery frame type packet, or a short probe response type packet.

Example 45 includes the subject matter of Example 36, and optionally, wherein the low modulation packet further includes additional information, a backhaul throughput, access point capabilities, BSS load estimates, and estimated available airtime for the candidate access points, and wherein the logic is further to combine the additional information with the RSSI values and the corresponding addresses to trigger the transition.

Example 46 includes the subject matter of any one of Examples 32-34, and optionally, wherein the logic is further to compare the RSSI value of the low modulation packet from the candidate access point with an RSSI value associated with the serving access point or with other candidate access points, and to trigger transition to one of the candidate access points associated with a highest RSSI value, or to one of the candidate access points with an RSSI value above a predetermined RSSI threshold value.

Example 47 includes the subject matter of Example 46, and optionally, wherein the logic is to cause a transmission of information on the predetermined RSSI threshold value from the device to the serving access point.

Example 48 includes the subject matter of Example 46, and optionally, wherein the frame is a neighbor report frame from the serving access point having a neighbor report common part, and a neighbor report per candidate access point part, and wherein the neighbor report frame includes information on the predetermined RSSI threshold value in the neighbor report common part or in the neighbor report per candidate access point part.

Example 49 includes the subject matter of Example 48, and optionally, wherein the logic is further to cause the processor to start scanning for the low modulation packet if an RSSI value of a packet from the serving access point is below the predetermined RSSI threshold.

Example 50 includes the subject matter of Example 42, and optionally, wherein the logic is further to calibrate an RSSI value of the packet configured according to the first wireless communication protocol from the serving access point or the RSSI value of the low modulation packet to allow the comparison.

Example 51 includes the subject matter of any one of Examples 32-34 or 38-45, and optionally, wherein the logic is further to determine an RSSI value of the low modulation packet when processing the packet configured according to the first wireless communication protocol from the serving access point.

Example 52 includes the subject matter of any one of Examples 32-34 or 38-45, and optionally, wherein the logic is further to determine the RSSI value of the low modulation packet when in a power-save mode.

Example 53 includes the subject matter of any one of Examples 32-34 or 38-45, and optionally, further including a first radio and first front-end module to carry signals configured according to the first wireless communication protocol, a first baseband processor connected to the first radio and first front-end module, a second radio and second front-end module to carry signals configured according to the second wireless communication protocol, and a second baseband processor connected to the second radio and second front-end module.

Example 54 includes the subject matter of Example 53, and optionally, further including one or more antennas connected to the first front-end module and the second front end module to communicate signals configured according to the first wireless communication protocol and the second wireless communication protocol.

Example 55 includes the subject matter of Example 36, and optionally, wherein the other wireless communication device is an Evolved Node B (eNodeB), and the frame is from the eNodeB and is configured according to a cellular communication protocol.

Example 56 includes the subject matter of Example 55, where the cellular communication protocol is a Long-Term Evolution (LTE) standard or a 5^{th} Generation Mobile Networks Standard.

Example 57 includes the subject matter of any one of Examples 32-34, and optionally, wherein the modulation rate of the low modulation packet is an On-Off Keying (OOK) modulation rate.

Example 58 includes the subject matter of any one of Examples 32-34, and optionally, wherein the first and second wireless communication protocol both use orthogonal frequency division multiplexing (OFDM).

Example 59 includes the subject matter of Example 58, and optionally, wherein a subcarrier width for the low modulation packet may be 312.5 kHz.

Example 60 includes the subject matter of Example 57, and optionally, wherein an OOK pulse bandwidth of the low modulation packet is 4.06 MHz.

Example 61 includes the subject matter of Example 57, and optionally, wherein an OOK pulse bandwidth includes 13 subcarriers.

Example 62 includes the subject matter of any one of Examples 32-34, and optionally, wherein the packet configured according to the first wireless communication protocol from the serving access point and the low modulation packet configured according to the second wireless communication protocol from the candidate access point both have a legacy PHY preamble according to the first wireless communication protocol.

Example 63 includes a method to be performed by a wireless communication device, the method including processing a packet configured according to a first wireless communication protocol from a serving access point; processing a low modulation packet configured according to a second wireless communication protocol from a candidate access point, the low modulation packet being at a modulation rate lower than a lowest modulation rate for the first wireless communication protocol; determining a received signal strength indicator (RSSI) value of the low modulation packet; processing a frame including information on an address of the candidate access point, the frame being from the serving access point, from the candidate access point, or from another wireless communication device; associating the RSSI value with the address of the candidate access point; and triggering transition of the device from the serving access point to the candidate access point based on the RSSI value and on the address of the candidate access point.

Example 64 includes the subject matter of Example 63, and optionally, wherein the second wireless communication protocol includes a low-power wake-up receiver (LP-WUR) protocol conforming to Institute for Electronic and Electrical Engineers (IEEE) 802.11 standard, and wherein the modulation rate of the low modulation packet is an On-Off Keying (OOK) modulation rate.

Example 65 includes the subject matter of Example 63, and optionally, wherein the first communication protocol includes a standard from an 802.11 standards family of the Institute for Electronic and Electrical Engineers (IEEE), the lowest modulation rate being a Binary Phase Shift Keying (BPSK) modulation rate.

Example 66 includes the subject matter of any one of Examples 63-65, and optionally, wherein the low modulation packet is sent on a wireless channel that has a bandwidth of about 5 MHz or less.

Example 67 includes the subject matter of any one of Examples 63-65, and optionally, wherein the candidate access point includes a plurality of candidate access points; the address of a candidate access point includes a plurality of addresses for respective ones of the candidate access points; the candidate BSS includes a plurality of candidate BSSs each corresponding to a respective one of the candidate access points; the low modulation packet includes a plurality of low modulation packets, each of the low modulation packets further being from a corresponding one of the candidate access points and further being at a modulation rate lower than a lowest modulation rate for the first wireless communication protocol; the RSSI value includes a plurality of RSSI values for each of the low modulation packets; and the method further includes triggering transition of the device from the serving access point and the candidate BSS to one of the plurality of candidate access points and its corresponding candidate BSS based on the RSSI values and the corresponding addresses of the candidate access points.

Example 68 includes the subject matter of Example 67, and optionally, wherein the frame is a neighbor report frame from the serving access point, the neighbor report frame including information on a timing for a transmission of the low modulation packet from the candidate access point to allow the logic to associate the RSSI value with the address of the candidate access point.

Example 69 includes the subject matter of Example 68, and optionally, wherein the frame is configured according to the first wireless communication protocol.

Example 70 includes the subject matter of Example 68, and optionally, wherein the information on the timing for the transmission of the low modulation packet includes at least one of a target transmission time of the low modulation packet and an interval at which the low modulation packet is to be transmitted.

Example 71 includes the subject matter of Example 63, and optionally, wherein the frame includes the low modulation packet and is from the candidate access point, and wherein the low modulation packet includes the information on the address of the candidate access point.

Example 72 includes the subject matter of Example 63, and optionally, wherein the low modulation packet is a first low modulation packet, and the method further includes: processing a second low modulation packet configured according to the second wireless communication protocol from the serving access point, the second low modulation packet being at the power level that is lower than a lowest power level for the first wireless communication protocol, determining an RSSI value of the second low modulation packet, triggering transition of the device from the serving access point to the candidate access point based on a comparison of the RSSI value of the first low modulation packet with the RSSI value of the second low modulation packet.

Example 73 includes the subject matter of Example 63, and optionally, wherein the frame is from the serving access point, the device further including logic to: determine an RSSI value of the packet configured according to the first wireless communication protocol from the serving access point or of the frame sent from the serving access point, trigger transition of the device from the serving access point to the candidate access point based on a comparison of the RSSI value of the low modulation packet with the RSSI value of the packet configured according to the first wireless communication protocol from the serving access point or of the frame sent from the serving access point.

Example 74 includes the subject matter of Example 63, and optionally, wherein the low modulation packet further includes information in a field that the low modulation packet is of a received signal strength indicator (RSSI) measurement type.

Example 75 includes the subject matter of Example 63, and optionally, wherein the low modulation packet is in a management frame, and is a short beacon type packet, a short discovery frame type packet, or a short probe response type packet.

Example 76 includes the subject matter of Example 67, and optionally, wherein the low modulation packet further includes additional information, a backhaul throughput, access point capabilities, BSS load estimates, and estimated available airtime for the candidate access points, and wherein the method further includes combining the additional information with the RSSI values and the corresponding addresses to trigger the transition.

Example 77 includes the subject matter of any one of Examples 63-65, and optionally, wherein the method further includes comparing the RSSI value of the low modulation packet from the candidate access point with an RSSI value associated with the serving access point or with other candidate access points, and to trigger transition to one of the candidate access points associated with a highest RSSI value, or to one of the candidate access points with an RSSI value above a predetermined RSSI threshold value.

Example 78 includes the subject matter of Example 77, and optionally, wherein the method further includes causing a transmission of information on the predetermined RSSI threshold value from the device to the serving access point.

Example 79 includes the subject matter of Example 77, and optionally, wherein the frame is a neighbor report frame from the serving access point having a neighbor report common part, and a neighbor report per candidate access point part, and wherein the neighbor report frame includes information on the predetermined RSSI threshold value in the neighbor report common part or in the neighbor report per candidate access point part.

Example 80 includes the subject matter of Example 77, and optionally, wherein the method further includes causing the processor to start scanning for the low modulation packet if an RSSI value of a packet from the serving access point is below the predetermined RSSI threshold.

Example 81 includes the subject matter of Example 73, and optionally, wherein the method further includes calibrating an RSSI value of the packet configured according to the first wireless communication protocol from the serving access point or the RSSI value of the low modulation packet to allow the comparison.

Example 82 includes the subject matter of any one of Examples 63-65 and 71-76, and optionally, wherein the method further includes determining an RSSI value of the low modulation packet when processing the packet configured according to the first wireless communication protocol from the serving access point.

Example 83 includes the subject matter of any one of Examples 63-65 and 71-76, and optionally, wherein the method further includes determining the RSSI value of the low modulation packet when in a power-save mode.

Example 84 includes the subject matter of any one of Examples 63-65, and optionally, further including: using a first radio and first front-end module to carry signals configured according to the first wireless communication protocol, using a first baseband processor connected to the first radio and first front-end module, using a second radio and second front end module to carry signals configured according to the second wireless communication protocol, and using a second baseband processor connected to the second radio and second front-end module.

Example 85 includes the subject matter of Example 84, and optionally, further including: using one or more antennas connected to the first front-end module and the second front end module to communicate signals configured according to the first wireless communication protocol and the second wireless communication protocol.

Example 86 includes the subject matter of Example 67, and optionally, wherein the other wireless communication device is an Evolved Node B (eNodeB), and the frame is from the eNodeB and is configured according to a cellular communication protocol.

Example 87 includes the subject matter of Example 86, where the cellular communication protocol is a Long-Term Evolution (LTE) standard or a 5^{th} Generation Mobile Networks Standard.

Example 88 includes the subject matter of any one of Examples 63-65, and optionally, wherein the modulation rate of the low modulation packet is an On-Off Keying (OOK) modulation rate.

Example 89 includes the subject matter of any one of Examples 63-65, and optionally, wherein the first and second wireless communication protocols both use orthogonal frequency division multiplexing (OFDM).

Example 90 includes the subject matter of Example 89, and optionally, wherein a subcarrier width for the low modulation packet may be 312.5 kHz.

Example 91 includes the subject matter of Example 88, and optionally, wherein an OOK pulse bandwidth of the low modulation packet is 4.06 MHz.

Example 92 includes the subject matter of Example 88, and optionally, wherein an OOK pulse bandwidth includes 13 subcarriers.

Example 93 includes the subject matter of any one of Examples 63-65, and optionally, wherein the packet configured according to the first wireless communication protocol from the serving access point and the low modulation packet configured according to the second wireless communication protocol from the candidate access point both have a legacy PHY preamble according to the first wireless communication protocol.

Example 94 includes a product comprising one or more tangible computer-readable non-transitory storage media comprising computer-executable instructions operable to, when executed by at least one computer processor, enable the at least one computer processor to implement operations at a wireless communication device, the operations comprising: processing a packet configured according to a first wireless communication protocol from a serving access point; processing a low modulation packet configured according to a second wireless communication protocol from a candidate access point, the low modulation packet being at a modulation rate lower than a lowest modulation rate for the first wireless communication protocol; determining a received signal strength indicator (RSSI) value of the low modulation packet; processing a frame including information on an address of the candidate access point, the frame being from the serving access point, from the candidate access point, or from another wireless communication device; associating the RSSI value with the address of the candidate access point; and triggering transition of the device from the serving access point to the candidate access point based on the RSSI value and on the address of the candidate access point.

Example 95 includes the subject matter of Example 94, and optionally, wherein the second wireless communication protocol includes a low-power wake-up receiver (LP-WUR) protocol conforming to Institute for Electronic and Electrical Engineers (IEEE) 802.11 standard.

Example 96 includes the subject matter of Example 94, and optionally, wherein the first communication protocol includes a standard from an 802.11 standards family of the Institute for Electronic and Electrical Engineers (IEEE), the lowest modulation rate being a Binary Phase Shift Keying (BPSK) modulation rate.

Example 97 includes the subject matter of any one of Examples 94-96, and optionally, wherein the low modulation packet is sent on a wireless channel that has a bandwidth of about 5 MHz or less.

Example 98 includes the subject matter of any one of Examples 94-96, and optionally, wherein the candidate access point includes a plurality of candidate access points; the address of a candidate access point includes a plurality of addresses for respective ones of the candidate access points; the candidate BSS includes a plurality of candidate BSSs each corresponding to a respective one of the candidate access points; the low modulation packet includes a plurality of low modulation packets, each of the low modulation packets further being from a corresponding one of the candidate access points and further being at a modulation rate lower than a lowest modulation rate for the first wireless communication protocol; the RSSI value includes a plurality of RSSI values for each of the low modulation packets; and the operations further include triggering transition of the device from the serving access point and the candidate BSS to one of the plurality of candidate access points and its corresponding candidate BSS based on the RSSI values and the corresponding addresses of the candidate access points.

Example 99 includes the subject matter of Example 98, and optionally, wherein the frame is a neighbor report frame from the serving access point, the neighbor report frame including information on a timing for a transmission of the low modulation packet from the candidate access point to allow the logic to associate the RSSI value with the address of the candidate access point.

Example 100 includes the subject matter of Example 99, and optionally, wherein the frame is configured according to the first wireless communication protocol.

Example 101 includes the subject matter of Example 99, and optionally, wherein the information on the timing for the transmission of the low modulation packet includes at least one of a target transmission time of the low modulation packet and an interval at which the low modulation packet is to be transmitted.

Example 102 includes the subject matter of Example 94, and optionally, wherein the frame includes the low modulation packet and is from the candidate access point, and wherein the low modulation packet includes the information on the address of the candidate access point.

Example 103 includes the subject matter of Example 94, and optionally, wherein the low modulation packet is a first low modulation packet, and the operations further include: processing a second low modulation packet configured according to the second wireless communication protocol from the serving access point, the second low modulation packet being at the power level that is lower than a lowest power level for the first wireless communication protocol, determining an RSSI value of the second low modulation packet, triggering transition of the device from the serving access point to the candidate access point based on a comparison of the RSSI value of the first low modulation packet with the RSSI value of the second low modulation packet.

Example 104 includes the subject matter of Example 94, and optionally, wherein the frame is from the serving access point, the device further including logic to: determine an RSSI value of the packet configured according to the first wireless communication protocol from the serving access point or of the frame sent from the serving access point, and trigger transition of the device from the serving access point to the candidate access point based on a comparison of the RSSI value of the low modulation packet with the RSSI value of the packet configured according to the first wireless communication protocol from the serving access point or of the frame sent from the serving access point.

Example 105 includes the subject matter of Example 94, and optionally, wherein the low modulation packet further includes information in a field that the low modulation packet is of a received signal strength indicator (RSSI) measurement type.

Example 106 includes the subject matter of Example 94, and optionally, wherein the low modulation packet is in a management frame, and is a short beacon type packet, a short discovery frame type packet, or a short probe response type packet.

Example 107 includes the subject matter of Example 98, and optionally, wherein the low modulation packet further includes additional information, a backhaul throughput, access point capabilities, BSS load estimates, and estimated available airtime for the candidate access points, and wherein the operations further include combining the additional information with the RSSI values and the corresponding addresses to trigger the transition.

Example 108 includes the subject matter of any one of Examples 94-96, and optionally, wherein the operations further include comparing the RSSI value of the low modulation packet from the candidate access point with an RSSI value associated with the serving access point or with other candidate access points, and to trigger transition to one of the candidate access points associated with a highest RSSI value, or to one of the candidate access points with an RSSI value above a predetermined RSSI threshold value.

Example 109 includes the subject matter of Example 108, and optionally, wherein the operations further include causing a transmission of information on the predetermined RSSI threshold value from the device to the serving access point.

Example 110 includes the subject matter of Example 108, and optionally, wherein the frame is a neighbor report frame from the serving access point having a neighbor report common part, and a neighbor report per candidate access point part, and wherein the neighbor report frame includes information on the predetermined RSSI threshold value in the neighbor report common part or in the neighbor report per candidate access point part.

Example 111 includes the subject matter of Example 108, and optionally, wherein the operations further include causing the processor to start scanning for the low modulation packet if an RSSI value of a packet from the serving access point is below the predetermined RSSI threshold.

Example 112 includes the subject matter of Example 104, and optionally, wherein the operations further include calibrating an RSSI value of the packet configured according to the first wireless communication protocol from the serving access point or the RSSI value of the low modulation packet to allow the comparison.

Example 113 includes the subject matter of any one of Examples 94-96 and 102-107, and optionally, wherein the operations further include determining an RSSI value of the low modulation packet when processing the packet configured according to the first wireless communication protocol from the serving access point.

Example 114 includes the subject matter of any one of Examples 94-96 and 104-107, wherein the operations further include determining the RSSI value of the low modulation packet when in a power-save mode.

Example 115 includes the subject matter of any one of Examples 94-96, and optionally, further including: a first radio and first front-end module to carry signals configured according to the first wireless communication protocol, a first baseband processor connected to the first radio and first front-end module, a second radio and second front-end module to carry signals configured according to the second wireless communication protocol, and a second baseband processor connected to the second radio and second front-end module.

Example 116 includes the subject matter of Example 115, and optionally, further including one or more antennas connected to the first front-end module and the second front end module to communicate signals configured according to the first wireless communication protocol and the second wireless communication protocol.

Example 117 includes the subject matter of Example 98, and optionally, wherein the other wireless communication device is an Evolved Node B (eNodeB), and the frame is from the eNodeB and is configured according to a cellular communication protocol.

Example 118 includes the subject matter of Example 116, where the cellular communication protocol is a Long-Term Evolution (LTE) standard or a 5^{th} Generation Mobile Networks Standard.

Example 119 includes the subject matter of Example 94, and optionally, wherein the modulation rate of the low modulation packet is an On-Off Keying (OOK) modulation rate.

Example 120 includes the subject matter of any one of Examples 94-96, and optionally, wherein the first and second wireless communication protocol both use orthogonal frequency division multiplexing (OFDM).

Example 121 includes the subject matter of Example 120, and optionally, wherein a subcarrier width for the low modulation packet may be 312.5 kHz.

Example 122 includes the subject matter of Example 119, and optionally, wherein an OOK pulse bandwidth of the low modulation packet is 4.06 MHz.

Example 123 includes the subject matter of Example 119, and optionally, wherein an OOK pulse bandwidth includes 13 subcarriers.

Example 124 includes the subject matter of any one of Examples 94-96, and optionally, wherein the packet configured according to the first wireless communication protocol from the serving access point and the low modulation packet configured according to the second wireless communication protocol from the candidate access point both have a legacy PHY preamble according to the first wireless communication protocol.

Example 125 includes a wireless communication device including: means for processing a packet configured according to a first wireless communication protocol from a serving access point; means for processing a low modulation packet configured according to a second wireless communication protocol from a candidate access point, the low modulation packet being at a modulation rate lower than a lowest modulation rate for the first wireless communication protocol; means for determining a received signal strength indicator (RSSI) value of the low modulation packet, means for processing a frame including information on an address of the candidate access point, the frame being from the serving access point, from the candidate access point, or from another wireless communication device; means for associating the RSSI value with the address of the candidate access point; means for triggering transition of the device from the serving access point to the candidate access point based on the RSSI value and on the address of the candidate access point.

Example 126 includes the subject matter of Example 125, and optionally, wherein: the second wireless communication protocol includes a low-power wake-up receiver (LP-WUR) protocol conforming to Institute for Electronic and Electrical Engineers (IEEE) 802.11 standard, the modulation rate of the low modulation packet being an On-Off Keying (OOK) modulation rate, and the first communication protocol includes a standard from an 802.11 standards family of the Institute for Electronic and Electrical Engineers (IEEE), the lowest modulation rate being a Binary Phase Shift Keying (BPSK) modulation rate.

Example 127 includes the subject matter of Example 125, and optionally, wherein: the candidate access point includes a plurality of candidate access points; the address of a candidate access point includes a plurality of addresses for respective ones of the candidate access points; the candidate BSS includes a plurality of candidate BSSs each corresponding to a respective one of the candidate access points; the low modulation packet includes a plurality of low modulation packets, each of the low modulation packets further being from a corresponding one of the candidate access points and further being at a modulation rate lower than a lowest modulation rate for the first wireless communication protocol; the RSSI value includes a plurality of RSSI values for each of the low modulation packets; and the means for triggering is to trigger transition of the device from the serving access point and the candidate BSS to one of the plurality of candidate access points and its corresponding candidate BSS based on the RSSI values and the corresponding addresses of the candidate access points.

Example 128 includes the subject matter of any one of Examples 125-127, and optionally, wherein the frame is a neighbor report frame from the serving access point configured according to the first wireless communication protocol, the neighbor report frame including information on a timing for a transmission of the low modulation packet from the candidate access, and the device further including logic to associate the RSSI value with the address of the candidate access point, the information on the timing for the transmission of the low modulation packet including at least one of a target transmission time of the low modulation packet and an interval at which the low modulation packet is to be transmitted.

Example 129 includes the subject matter of any one of Examples 125-127, and optionally, wherein the frame includes the low modulation packet and is from the candidate access point, and wherein the low modulation packet includes the information on the address of the candidate access point.

Example 130 includes the subject matter of any one of Examples 125-127, and optionally, wherein the frame is from the serving access point, the device further including: means for determining an RSSI value of the packet configured according to the first wireless communication protocol from the serving access point or of the frame sent from the serving access point, and means for triggering transition of the device from the serving access point to the candidate access point based on a comparison of the RSSI value of the low modulation packet with the RSSI value of the packet configured according to the first wireless communication protocol from the serving access point or of the frame sent from the serving access point.

Example 131 includes the subject matter of any one of Examples 125-127, and optionally, further including means for comparing the RSSI value of the low modulation packet from the candidate access point with an RSSI value associated with the serving access point or with other candidate access points, and optionally, wherein the means for triggering is to trigger transition to one of the candidate access points associated with a highest RSSI value, or to one of the candidate access points with an RSSI value above a predetermined RSSI threshold value.

Example 132 includes the subject matter of any one of Examples 125-127, and optionally, wherein the packet configured according to the first wireless communication protocol from the serving access point and the low modulation packet configured according to the second wireless communication protocol from the candidate access point both have a legacy PHY preamble according to the first wireless communication protocol.

Example 133 includes a wireless communication device including: a memory and processing circuitry coupled to the memory and including logic to: process a packet configured according to a first wireless communication protocol from a wireless station, and cause transmission to the wireless station of a low modulation packet configured according to a second wireless communication protocol, the low modulation packet being at a modulation rate lower than a lowest modulation rate for the first wireless communication protocol, wherein the packet configured according to the first wireless communication protocol and the low modulation packet configured according to the second wireless communication protocol both have a legacy PHY preamble according to the first wireless communication protocol.

Example 134 includes the subject matter of Example 133, and optionally, wherein: the second wireless communication protocol includes a low-power wake-up receiver (LP-WUR) protocol conforming to Institute for Electronic and Electrical Engineers (IEEE) 802.11 standard, the modulation rate of the low modulation packet being an On-Off Keying (OOK) modulation rate, and the first communication protocol includes a standard from an 802.11 standards family of the Institute for Electronic and Electrical Engineers (IEEE), the lowest modulation rate being a Binary Phase Shift Keying (BPSK) modulation rate.

Example 135 includes the subject matter of any one of Examples 133-134, and optionally, wherein: the low modulation packet includes a plurality of low modulation packets, each of the low modulation packets further being at a modulation rate lower than a lowest modulation rate for the first wireless communication protocol, and the logic is further to cause transmission of the low modulation wireless packets at a predetermined time interval and at predetermined target transmission times, and to cause transmission of beacons or pre-association frames including information on the predetermined time interval and at predetermined target transmission times.

Example 136 includes the subject matter of any one of Examples 133-134, and optionally, wherein the logic is further to cause transmission of a neighbor report frame configured according to the first wireless communication protocol or to another wireless communication protocol and including information on a timing for a transmission of the low modulation packet, the information on the timing for the transmission of the low modulation packet including at least one of a target transmission time of the low modulation packet and an interval at which the low modulation packet is to be transmitted.

Example 137 includes the subject matter of any one of Examples 133-134, and optionally, wherein the wireless device is to be used as part of an access point, and wherein the low modulation packet includes information on an address of the access point.

Example 138 includes the subject matter of any one of Examples 133-134, and optionally, wherein the low modulation packet further includes information in a field as to whether the low modulation packet is of a received signal strength indicator (RSSI) measurement type.

Example 139 includes the subject matter of any one of Examples 133-134, and optionally, wherein the low modulation packet further includes additional information, a backhaul throughput, access point capabilities, BSS load estimates, and estimated available airtime for the access point.

Example 140 includes the subject matter of any one of Examples 133-134, and optionally, further including: a first radio and first front-end module to carry signals configured according to the first wireless communication protocol, a first baseband processor connected to the first radio and first front-end module, a second radio and second front-end module to carry signals configured according to the second wireless communication protocol, and a second baseband processor connected to the second radio and second front-end module.

Example 141 includes the subject matter of Example 140, and optionally, further including one or more antennas connected to the first front-end module and the second front end module to communicate signals configured according to the first wireless communication protocol and the second wireless communication protocol.

Example 142 includes the subject matter of Example 136, and optionally, wherein the wireless device is to be part of an Evolved Node B (eNodeB), and wherein the other wireless communication protocol is a cellular communication protocol.

Example 143 includes the subject matter of any one of Examples 133-134, and optionally, wherein the modulation rate of the low modulation packet is an On-Off Keying (OOK) modulation rate.

Example 144 includes a product comprising one or more tangible computer-readable non-transitory storage media comprising computer-executable instructions operable to, when executed by at least one computer processor, enable the at least one computer processor to implement operations at a wireless communication device, the operations comprising: processing a packet configured according to a first wireless communication protocol from a wireless station, causing transmission to the wireless station of a low modulation packet configured according to a second wireless communication protocol, the low modulation packet being at a modulation rate lower than a lowest modulation rate for the first wireless communication protocol, wherein the packet configured according to the first wireless communication protocol and the low modulation packet configured according to the second wireless communication protocol both have a legacy PHY preamble according to the first wireless communication protocol.

Example 145 includes the product of Example 144, and optionally, wherein: the second wireless communication protocol includes a low-power wake-up receiver (LP-WUR) protocol conforming to Institute for Electronic and Electrical Engineers (IEEE) 802.11 standard, and the modulation rate of the low modulation packet is an On-Off Keying (OOK) modulation rate, and the first communication protocol includes a standard from an 802.11 standards family of the Institute for Electronic and Electrical Engineers (IEEE), the lowest modulation rate being a Binary Phase Shift Keying (BPSK) modulation rate.

Example 146 includes the product of any one of Examples 144-145, and optionally, wherein the wireless device is to be used as part of an access point, and wherein the low modulation packet includes information on an address of the access point.

Example 147 includes the product of any one of Examples 144-145, and optionally, further including causing transmission of a neighbor report frame including information on a timing for a transmission of the low modulation packet from the candidate access point to allow the logic to associate the RSSI value with the address of the candidate access point.

Example 148 includes a method to be performed at a wireless communication device, the method comprising: processing a packet configured according to a first wireless communication protocol from a wireless station, causing transmission to the wireless station of a low modulation packet configured according to a second wireless communication protocol, the low modulation packet being at a modulation rate lower than a lowest modulation rate for the first wireless communication protocol, wherein the packet configured according to the first wireless communication protocol and the low modulation packet configured according to the second wireless communication protocol both have a legacy PHY preamble according to the first wireless communication protocol.

Example 149 includes the method of Example 148, and optionally, wherein: the second wireless communication protocol includes a low-power wake-up receiver (LP-WUR) protocol conforming to Institute for Electronic and Electrical Engineers (IEEE) 802.11 standard, and the modulation rate of the low modulation packet is an On-Off Keying (OOK) modulation rate, and the first communication protocol includes a standard from an 802.11 standards family of the Institute for Electronic and Electrical Engineers (IEEE), the lowest modulation rate being a Binary Phase Shift Keying (BPSK) modulation rate.

Example 150 includes the method of any one of Examples 148-149, and optionally, wherein the wireless device is to be used as part of an access point, and wherein the low modulation packet includes information on an address of the access point.

Example 151 includes the method of any one of Examples 148-149, and optionally, further including causing transmission of a neighbor report frame including information on a timing for a transmission of the low modulation packet from the candidate access point to allow the logic to associate the RSSI value with the address of the candidate access point.

Example 152 includes a wireless communication device, the device including: means for processing a packet configured according to a first wireless communication protocol from a wireless station, and means for causing transmission to the wireless station of a low modulation packet configured according to a second wireless communication protocol, the low modulation packet being at a modulation rate lower than a lowest modulation rate for the first wireless communication protocol; wherein the packet configured according to the first wireless communication protocol and the low modulation packet configured according to the second wireless communication protocol both have a legacy PHY preamble according to the first wireless communication protocol.

Example 153 includes the subject matter of Example 152, and optionally, wherein: the second wireless communication protocol includes a low-power wake-up receiver (LP-WUR) protocol conforming to Institute for Electronic and Electrical Engineers (IEEE) 802.11 standard, and the modulation rate of the low modulation packet is an On-Off Keying (OOK) modulation rate, and the first communication protocol includes a standard from an 802.11 standards family of the Institute for Electronic and Electrical Engineers (IEEE), the lowest modulation rate being a Binary Phase Shift Keying (BPSK) modulation rate.

Example 154 includes the subject matter of any one of Examples 152-153, and optionally, wherein the wireless device is to be used as part of an access point, and wherein the low modulation packet includes information on an address of the access point.

Example 155 includes the subject matter of any one of Examples 152-53, and optionally, further including causing transmission of a neighbor report frame including information on a timing for a transmission of the low modulation packet from the candidate access point to allow the logic to associate the RSSI value with the address of the candidate access point.

Advantageously, demonstrative embodiments allow a comparison of the RSSI value of a packet or frame from the serving access point with an RSSI value of a packet from the candidate access point to trigger BSS transition using, for example, the LP-WUR wireless communication protocol. Scanning for a better access point than the serving access point according to demonstrative embodiments can be very short as compared with the prior art, and can even be performed while having a main radio, such as a Wi-Fi radio, still receiving and/or transmitting from/to its serving access point. A STA in sleep mode, not transmitting or receiving data, can keep track of the best access point to connect to even during mobility with a very low power consumption.

What is claimed is:

1. A wireless communication device including a memory and processing circuitry coupled to the memory and including logic to:
process a packet configured according to a first wireless communication protocol from a serving access point,
process a low modulation packet configured according to a second wireless communication protocol from a candidate access point, the low modulation packet being at a modulation rate lower than a lowest modulation rate for the first wireless communication protocol;
process a frame including information on an address of the candidate access point, the frame being from the serving access point, from the candidate access point, or from another wireless communication device;
associate an RSSI value of the low modulation packet with the address of the candidate access point;
trigger transition of the device from the serving access point to the candidate access point based on the RSSI value and on the address of the candidate access point.

2. The device of claim 1, wherein:
the second wireless communication protocol includes a low-power wake-up receiver (LP-WUR) protocol conforming to Institute for Electronic and Electrical Engineers (IEEE) 802.11 standard, the modulation rate of the low modulation packet being an On-Off Keying (OOK) modulation rate; and
the first wireless communication protocol includes a standard from an 802.11 standards family of the Institute for Electronic and Electrical Engineers (IEEE), the lowest modulation rate being a Binary Phase Shift Keying (BPSK) modulation rate.

3. The device of claim 1, wherein:
the candidate access point includes a plurality of candidate access points;
the address of a candidate access point includes a plurality of addresses for respective ones of the candidate access points;
the low modulation packet includes a plurality of low modulation packets, each of the low modulation packets further being from a corresponding one of the candidate access points and further being at a modulation rate lower than a lowest modulation rate for the first wireless communication protocol;
the RSSI value includes a plurality of RSSI values for each of the low modulation packets; and
the logic is to trigger transition of the device from the serving access point to one of the plurality of candidate access points based on the RSSI values and the corresponding addresses of the candidate access points.

4. The device of claim 1, wherein the frame is a neighbor report frame from the serving access point configured according to the first wireless communication protocol, the neighbor report frame including information on a timing for a transmission of the low modulation packet from the candidate access point to allow the logic to associate the RSSI value with the address of the candidate access point, the information on the timing for the transmission of the low modulation packet including at least one of a target transmission time of the low modulation packet and an interval at which the low modulation packet is to be transmitted.

5. The device of claim 1, wherein the frame includes the low modulation packet and is from the candidate access point, and wherein the low modulation packet includes the information on the address of the candidate access point.

6. The device of claim 1, wherein the frame is from the serving access point, the device further including logic to:
determine an RSSI value of the packet configured according to the first wireless communication protocol from the serving access point or of the frame sent from the serving access point;
trigger transition of the device from the serving access point to the candidate access point based on a comparison of the RSSI value of the low modulation packet with the RSSI value of the packet configured according to the first wireless communication protocol from the serving access point or of the frame sent from the serving access point.

7. The device of claim 1, wherein the logic is further to compare the RSSI value of the low modulation packet from the candidate access point with an RSSI value associated with the serving access point or with other candidate access points, and to trigger transition to one of the candidate access points associated with a highest RSSI value, or to one of the candidate access points with an RSSI value above a predetermined RSSI threshold value.

8. The device of claim 1, further including:
a first radio and first front-end module to carry signals configured according to the first wireless communication protocol;
a first baseband processor connected to the first radio and first front-end module;
a second radio and second front-end module to carry signals configured according to the second wireless communication protocol;
a second baseband processor connected to the second radio and second front-end module;
one or more antennas connected to the first front-end module and the second front end module to communicate signals configured according to the first wireless communication protocol and the second wireless communication protocol.

9. The device of claim 1, wherein the packet configured according to the first wireless communication protocol from the serving access point and the low modulation packet configured according to the second wireless communication protocol from the candidate access point both have a legacy PHY preamble according to the first wireless communication protocol.

10. A product comprising one or more tangible computer-readable non-transitory storage media comprising computer-executable instructions operable to, when executed by at least one computer processor, enable the at least one computer processor to implement operations at a wireless communication device, the operations comprising:
processing a packet configured according to a first wireless communication protocol from a serving access point,
processing a low modulation packet configured according to a second wireless communication protocol from a candidate access point, the low modulation packet being at a modulation rate lower than a lowest modulation rate for the first wireless communication protocol;
determining a received signal strength indicator (RSSI) value of the low modulation packet;
processing a frame including information on an address of the candidate access point, the frame being from the serving access point, from the candidate access point, or from another wireless communication device;
associating the RSSI value with the address of the candidate access point;
triggering transition of the device from the serving access point to the candidate access point based on the RSSI value and on the address of the candidate access point.

11. The product of claim 10, wherein:
the second wireless communication protocol includes a low-power wake-up receiver (LP-WUR) protocol conforming to Institute for Electronic and Electrical Engineers (IEEE) 802.11 standard, and the modulation rate of the low modulation packet is an On-Off Keying (OOK) modulation rate; and
the first communication protocol includes a standard from an 802.11 standards family of the Institute for Electronic and Electrical Engineering (IEEE), the lowest modulation rate being a Binary Phase Shift Keying (BPSK) modulation rate.

12. The product of claim 10, wherein the frame is a neighbor report frame from the serving access point, the neighbor report frame including information on a timing for a transmission of the low modulation packet from the candidate access point to allow the logic to associate the RSSI value with the address of the candidate access point.

13. The product of claim 10, wherein the frame includes the low modulation packet and is from the candidate access point, and wherein the low modulation packet includes the information on the address of the candidate access point.

14. The product of claim 10, wherein the frame is from the serving access point, the device further including logic to:
determine an RSSI value of the packet configured according to the first wireless communication protocol from the serving access point or of the frame sent from the serving access point;
trigger transition of the device from the serving access point to the candidate access point based on a comparison of the RSSI value of the low modulation packet with the RSSI value of the packet configured according to the first wireless communication protocol from the serving access point or of the frame sent from the serving access point.

15. The product of claim 10, further including:
a first radio and first front-end module to carry signals configured according to the first wireless communication protocol;
a first baseband processor connected to the first radio and first front-end module;
a second radio and second front-end module to carry signals configured according to the second wireless communication protocol;
a second baseband processor connected to the second radio and second front-end module; and
one or more antennas connected to the first and second front-end modules.

16. The product of claim 10, wherein the packet configured according to the first wireless communication protocol from the serving access point and the low modulation packet configured according to the second wireless communication protocol from the candidate access point both have a legacy PHY preamble according to the first wireless communication protocol.

17. A wireless communication device including:
a memory;
processing circuitry coupled to the memory and including logic to:
process a packet configured according to a first wireless communication protocol from a wireless station;
cause transmission to the wireless station of a low modulation packet configured according to a second wireless communication protocol, the low modulation packet being at a modulation rate lower than a lowest modulation rate for the first wireless communication protocol;
wherein the packet configured according to the first wireless communication protocol and the low modulation packet configured according to the second wireless communication protocol both have a legacy PHY preamble according to the first wireless communication protocol.

18. The device of claim 17, wherein:
the second wireless communication protocol includes a low-power wake-up receiver (LP-WUR) protocol conforming to Institute for Electronic and Electrical Engineers (IEEE) 802.11 standard; and
the first communication protocol includes a standard from an 802.11 standards family of the Institute for Electronic and Electrical Engineers (IEEE), the lowest modulation rate being a Binary Phase Shift Keying (BPSK) modulation rate.

19. The device of claim 17, wherein the logic is further to cause transmission of a neighbor report frame configured according to the first wireless communication protocol or to another wireless communication protocol and including information on a timing for a transmission of the low modulation packet, the information on the timing for the transmission of the low modulation packet including at least one of a target transmission time of the low modulation packet and an interval at which the low modulation packet is to be transmitted.

20. The device of claim 17, wherein the wireless communication device is to be used as part of an access point, and wherein the low modulation packet includes information on an address of the access point.

21. The device of claim 17, further including:
a first radio and first front-end module to carry signals configured according to the first wireless communication protocol;
a first baseband processor connected to the first radio and first front-end module;
a second radio and second front-end module to carry signals configured according to the second wireless communication protocol; and
a second baseband processor connected to the second radio and second front-end module.

22. A product comprising one or more tangible computer-readable non-transitory storage media comprising computer-executable instructions operable to, when executed by at least one computer processor, enable the at least one computer processor to implement operations at a wireless communication device, the operations comprising:
processing a packet configured according to a first wireless communication protocol from a wireless station;
causing transmission to the wireless station of a low modulation packet configured according to a second wireless communication protocol, the low modulation packet being at a modulation rate lower than a lowest modulation rate for the first wireless communication protocol;
wherein the packet configured according to the first wireless communication protocol and the low modulation packet configured according to the second wireless communication protocol both have a legacy PHY preamble according to the first wireless communication protocol.

23. The product of claim 22, wherein:
the second wireless communication protocol includes a low-power wake-up receiver (LP-WUR) protocol conforming to Institute for Electronic and Electrical Engineers (IEEE) 802.11 standard, and the modulation rate of the low modulation packet is an On-Off Keying (OOK) modulation rate; and
the first communication protocol includes a standard from an 802.11 standards family of the Institute for Electronic and Electrical Engineers (IEEE), the lowest modulation rate being a Binary Phase Shift Keying (BPSK) modulation rate.

24. The product of claim 22, wherein the wireless communication device is to be used as part of an access point, and wherein the low modulation packet includes information on an address of the access point.

25. The product of claim 22, wherein the packet configured according to the first wireless communication protocol is a neighbor report frame from the serving access point, the neighbor report frame including information on a timing for a transmission of the low modulation packet from the candidate access point to allow the logic to associate an RSSI value with the address of the candidate access point.
